(19) United States
(12) Patent Application Publication
(10) Pub. No.: US 2010/0265385 A1
(43) Pub. Date: Oct. 21, 2010

(54) Light Field Camera Image, File and Configuration Data, and Methods of Using, Storing and Communicating Same

(76) Inventors: Timothy J. Knight, Palo Alto, CA (US); Yi-Ren Ng, San Maeo, CA (US); Colvin Pitts, Mountain View, CA (US); Alex Fishman, San Jose, CA (US)

Correspondence Address: NEIL STEINBERG, 2300 M STREET, N.W., Suite 800, WASHINGTON, DC, 20037, US

(21) Appl. No.: 12/703,367

(22) Filed: Feb. 10, 2010

Related U.S. Application Data
(60) Provisional application No. 61/170,620, filed on Apr. 18, 2009.

(51) Int. Cl. H04N 5/225; G06K 9/00

(52) U.S. Cl. 348/340; 382/100; 348/345; 348/E05.024; 348/E05.045

(57) ABSTRACT

Certain devices and methods are directed to acquiring, generating and/or outputting image data corresponding to a scene. In one aspect, the method comprises (i) acquiring light field data which is representative of a light field from the scene, (ii) acquiring configuration data which is representative of how light rays optically propagate through the data acquisition device (used to acquire the light field data), (iii) generating first image data using the light field data and the configuration data, wherein the first image data includes a focus or focus depth that is different from a focus or focus depth of the light field data, (iv) generating a first electronic data file including (a) the first image data, (b) the light field data, and (c) the configuration data, and (v) outputting the first electronic data file. In one aspect, the light field acquisition device comprises optics, a light field sensor (located in the optical path of the optics) to acquire light field image data, processing circuitry to: (i) determine configuration data which is representative of how light rays optically propagate through the optics and light field sensor, and (ii) generate and output the electronic data file, wherein the electronic data file includes (a) image data, (b) light field data which is representative of a light field from the scene, and (c) configuration data. The device also includes memory (internal and/or external) to store the electronic data file.

### RELATED APPLICATION

This application claims priority to U.S. Provisional Application Ser. No. 61/170,620, entitled “Light Field Camera Image, File and Configuration Data, and Method of Using, Storing and Communicating Same”, filed Apr. 18, 2009. The contents of U.S. Provisional Application Ser. No. 61/170,620 are incorporated by reference herein, in their entirety.

### INTRODUCTION

In one aspect, the present inventions are directed to, among other things, Light Field Data Acquisition Devices (as defined in the Detailed Description, for example, light field cameras) that acquire Light Field Data (as also defined in the Detailed Description) or information, post-processing systems relating to such devices, and methods of using such cameras and systems. In another aspect, the present inventions are directed to obtaining, deriving, calculating, estimating, determining, storing and/or recording one or more characteristics, parameters and/or configurations of a Light Field Data Acquisition Device used in post-processing of the image data captured or acquired thereby. In yet another aspect, the present inventions are directed to providing or communicating (i) such characteristics, parameters and/or configurations and/or (ii) information which is representative of and/or used in generating, deriving, calculating, estimating and/or determining an optical and/or a geometric model of the image data acquisition device (for example, an optical and/or a geometric model of the image data acquisition device that is associated with certain acquired Light Field Data). Notably, such characteristics, parameters and/or configurations of the light field camera facilitate such cameras and/or systems to generate, manipulate and/or edit Light Field Data (for example, adjust, select, define and/or redefine the focus and/or depth of field—after initial acquisition or recording of the Light Field Data and/or information) of, for example, a scene. (See, for example, United States Patent Application Publication 2007/0252074, and the provisional applications to which it claims priority (namely, Ser. Nos. 60/615,179 and 60/647,492), and Ren Ng's PhD dissertation, “Digital Light Field Photography”, Stanford University 2006, all of which are incorporated here in their entirety by reference; and the block diagram illustration of a light field camera in FIGS. 1A and 1B).

In one embodiment, the characteristics, parameters and/or configurations of the Light Field Data Acquisition Device may provide information which is representative of an optical and/or a geometric model of the image data acquisition device (which may include, for example, the camera optics (for example, one or more lenses of any kind or type), imaging sensors to obtain and/or acquire the Light Field Data or information, and relative distances between the elements of the image data acquisition device). In this way, post-processing circuitry (for example, circuitry which is disposed in or integrated into an image data acquisition device (see FIG. 1B) or post-processing circuitry which is external to the image data acquisition device (see FIG. 1C)) may obtain, receive, acquire and/or determine such characteristics, parameters and/or configurations of the Light Field Data Acquisition Device and may determine, analyze and/or interpret the ray-geometry corresponding to one, some or all of imaging sensor pixel values associated with the imaging sensor in order to generate, manipulate and/or edit image data and/or information of, for example, a scene (for example, adjust, select, define and/or redefine the focus and/or depth of field—after initial acquisition and/or recording of the image data or information).

The data which is representative of the characteristics, parameters and/or configurations (hereinafter collectively “configuration data”) of the Light Field Data Acquisition Device may be obtained, determined and/or recorded before, during and/or after collection or acquisition of Light Field Data by the imaging sensor of the acquisition device (for example, light field camera). Such configuration data may be stored in the same data file and/or file format as the associated Light Field Data or in a different data file and/or different file format as the associated Light Field Data. In certain embodiments, the configuration data file is associated with a plurality of files each containing Light Field Data.

Where post-processing is performed “off-camera” or in a device or system separate from the Light Field Data Acquisition Device, such configuration data may be transmitted, provided and/or communicated to a external post-processing system together with or separate from the image data. (See, for example, FIG. 1C). Indeed, the data may be transmitted serially or in parallel with the electronic data files containing the Light Field Data.

Notably, a characteristic of a Light Field Data Acquisition Device provides the user the ability to compute images that are focused over a range of depths, corresponding to a range of virtual image planes about the physical plane where the light field sensor (which may include a microlens array and a photo sensor array) was positioned during data acquisition. With reference to FIG. 2A, this range of focusing corresponds to the range of (virtual) image plane depths a distance of c about the physical light field sensor plane. In FIG. 2A:
Lens plane may be characterized as the principal plane of the lenses; it may be advantageous to employ thin-lens simplifications of lenses in the illustrative diagrams, although these inventions are applicable to any lens configuration and/or system;
Far-focus plane may be characterized as the virtual plane optically conjugate to the furthest objects in the world that can be brought into a predetermined focus, for example, sharply into focus) using post image data acquisition focusing techniques of the light field;
Focal plane may be characterized as the plane in which rays emanating from optical infinity are brought into sharpest focus by the optics.
Light field sensor plane may be characterized as the plane in the data acquisition device where the principal plane of the microlens array in the light field sensor (for example, microlens array and image sensor assembly) is physically located;
Close-focus plane may be characterized as the virtual plane optically conjugate to the closest objects in the world that can be brought sharply into focus through software focusing of the light field;
v is equal to the distance between the lens plane and the light field sensor plane; and
ε₁ and ε₂ are equal to the maximum distances from the light field sensor plane that can be focused sharply after exposure—that is, after acquisition of image data.

With continued reference to FIG. 2A, the “world” or everything outside of the Light Field Data Acquisition device is to the left of the lens plane, and the device internals are illustrated to the right of the lens plane. Notably, FIG. 2A is not drawn to scale; indeed, ε₁ and ε₂ are often smaller than v (for example, ε₁<0.01*v and ε₂<0.01*v).

As intimated herein, although the present inventions are often described in the context of Light Field Data Acquisition Device, which acquire or obtain refocusable data or information and/or processes or methods of acquiring, generating, manipulating and/or editing such refocusable image data, the present inventions are applicable to other systems, devices, processes and/or methods of acquiring, generating, manipulating and/or editing refocusable image data. In this regard, refocusable image data are image data or information, no matter how acquired or obtained, that may be focused and/or re-focused after acquisition or recording of the data or information. For example, in one embodiment, refocusable image data or information is/are Light Field Data or information acquired or obtained, for example, via a Light Field Data Acquisition Device.

Notably, as discussed in detail below, the techniques of generating, manipulating and/or editing Light Field Data or information may be implemented via circuitry and techniques on/in the Light Field Data Acquisition Device and/or external post-processing system. Importantly, the present inventions are neither limited to any single aspect nor embodiment, nor to any combinations and/or permutations of such aspects and/or embodiments. Moreover, each of the aspects of the present inventions, and/or embodiments thereof, may be employed alone or in combination with one or more of the other aspects and/or embodiments thereof. For the sake of brevity, many of those permutations and combinations will not be discussed and/or illustrated separately herein.

### SUMMARY OF CERTAIN ASPECTS OF THE INVENTIONS

There are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations will not be discussed separately herein.

In a first principal aspect, certain of the present inventions are directed to a method of generating and outputting image data corresponding to a scene, comprising: (a) acquiring Light Field Data which is representative of a light field from the scene, wherein the Light Field Data is acquired using a data acquisition device; (b) acquiring configuration data which is representative of how light rays optically propagate through the data acquisition device; (c) generating first image data using the Light Field Data and the configuration data, wherein the first image data includes a focus or focus depth that is different from a focus or focus depth of the Light Field Data; (e) generating a first electronic data file including (1) the first image data, (2) the Light Field Data, and (3) the configuration data; and (f) outputting the first electronic data file (for example, to memory, processing circuitry, a Standard Display Mechanism (such as a printer or display)).

In one embodiment, generating the first electronic data file further includes arranging the first image data of the first electronic data file in a Standard Image Format (for example, JPEG, EXIF, BMP, PNG, PDF, TIFF and/or HD Photo data formats). In another embodiment, generating a first electronic data file further includes interleaving, threading, watermarking, encoding, multiplexing and/or meshing the first image data and the Light Field Data. Indeed, generating the first electronic data file may further include generating a header of the first electronic data file, wherein the header includes the configuration data.

The method of this aspect of the inventions may further include: (g) reading the first electronic data file; (h) displaying the first image data; (i) receiving a user input; (j) generating second image data, in response to the user input, using (1) the Light Field Data of the electronic data file and (2) the configuration data, wherein the second image data is different from the first image data; (k) generating a second electronic data file including (1) the second image data, (2) the Light Field Data, and (3) the configuration data; and (l) outputting the second electronic data file (for example, to memory, processing circuitry, a Standard Display Mechanism (such as a printer or display)).

The second image data may include a focus or focus depth that is different from the focus or focus depth of the first image data. Moreover, the second image data may be arranged in a Standard Image Format. Notably, generating a second electronic data file may further include interleaving, threading, watermarking, encoding, multiplexing and/or meshing the second image data and the Light Field Data.

The method of this aspect of the inventions may further include compressing the Light Field Data to generate compressed Light Field Data, and wherein the Light Field Data of the first electronic data file is the compressed Light Field Data.

In another embodiment, the method may further include: (g) reading the first electronic data file; (h) displaying the first image data; (i) receiving a user input; (j) generating second image data, in response to the user input, using (1) the Light Field Data of the electronic data file and (2) the configuration data, wherein the second image data is different from the first image data; (k) generating a second electronic data file including the second image data; and (l) outputting the second electronic data file.

In one embodiment, acquiring configuration data includes acquiring an N-bit key; and the method further includes determining optical model data by correlating the N-bit key to predetermined optical model data and wherein generating first image data includes generating first image data using the Light Field Data and the optical model data.

The configuration data may include data which is representative of an Aperture Function or an Exit Pupil which is associated with the acquisition of the Light Field Data. In addition thereto, or in lieu thereof, the configuration data may include data which is representative of a mapping from a two-dimensional position on a captured 2D array of pixel values of the data acquisition device to a four-dimensional parameterization of the light field from the scene.

In another principal aspect, certain of the present inventions are directed to a system to generate an image of a scene, comprising read circuitry to read a first electronic data file which is stored in a memory, wherein the first electronic data file includes (i) first image data, (ii) Light Field Data which is representative of a light field from the scene, and (iii) configuration data which is representative of how light rays optically propagate through a Light Field Data acquisition device. The system further includes a display to visually output an image using the first image data, a user interface to receive a user input, and processing circuitry, coupled to the read circuitry, the display and the user interface, to: (i) determine an optical model data using the configuration data, wherein the optical model data is representative of an optical model of the Light Field Data acquisition device, (ii) generate second image data, in response to the user input, using the Light Field Data and the optical model data, wherein the second image data includes a focus or focus depth that is different from a focus or focus depth of the first image data, and (iii) generate a second electronic data file including the second image data. The system of this aspect further includes write circuitry, coupled to the processing circuitry, to write the second electronic data file to the memory.

In one embodiment, the second electronic data file further includes (i) the Light Field Data which is representative of a light field from the scene, and (ii) the configuration data and/or the optical model data. The configuration data may include data which is representative of an Aperture Function or an Exit Pupil which is associated with the Light Field Data acquisition device that acquired the Light Field Data.

The processing circuitry may generate the second electronic data file by interleaving, threading, watermarking, encoding, multiplexing and/or meshing the second image data and the Light Field Data. In addition thereto, or in lieu thereof, the second electronic data file includes a header or the processing circuitry may generate a header of the second electronic data file, wherein the header includes the configuration data and/or the optical model data. Indeed, the processing circuitry may generate the first electronic data file by compressing the Light Field Data to generate compressed Light Field Data, and wherein the Light Field Data of the second electronic data file is the compressed Light Field Data.

In one embodiment, the processing circuitry arranges the first image data and/or the second image data of the second electronic data file in a Standard Image Format (for example, JPEG, EXIF, BMP, PNG, PDF, TIFF and/or HD Photo data formats).

In one embodiment, the configuration data of the first electronic data file includes an N-bit key, wherein the processing circuitry determines the optical model data by correlating the N-bit key to a plurality of different, predetermined optical model data.

In another principal aspect, certain of the present inventions are directed to a light field acquisition device for acquiring light field image data of a scene, comprising: optics, a light field sensor, located in the optical path of the optics, to acquire light field image data, a user interface to receive a user input, wherein, in response to the user input, the light field sensor acquires the light field image data of the scene, and processing circuitry, coupled the light field sensor and the user interface, to generate and output an electronic data file, the processing circuitry to: (a) determine configuration data which is representative of how light rays optically propagate through the optics and light field sensor, and (b) generate and output the electronic data file, wherein the electronic data file includes (i) image data (which may be arranged in a Standard Image Format), (ii) Light Field Data which is representative of a light field from the scene, and (iii) configuration data (for example, (1) data which is representative of an Aperture Function or Exit Pupil of the light field acquisition device and/or (2) data which is representative of a mapping from a two-dimensional position on a captured 2D array of pixel values to a four-dimensional parameterization of a light field from the scene). The light field acquisition device of this aspect of the inventions further includes memory, coupled to the processing circuitry, to store the electronic data file therein.

In one embodiment, the processing circuitry generates the electronic data file by interleaving, threading, watermarking, encoding, multiplexing and/or meshing the image data and the Light Field Data. In another embodiment, the processing circuitry generates the electronic data file by forming a header, wherein the header includes the configuration data. Indeed, in another embodiment, the processing circuitry generates the electronic data file by compressing the Light Field Data to generate compressed Light Field Data, and wherein the Light Field Data of the electronic data file is the compressed Light Field Data.

The configuration data of the electronic data file may include an N-bit key which is representative of predetermined optical model data.

In another embodiment, the processing circuitry may generate a header of the electronic data file, wherein the header includes the configuration data and/or the optical model data.

Again, there are many inventions, and aspects of the inventions, described and illustrated herein. This Summary is not exhaustive of the scope of the present inventions. Indeed, this Summary may not be reflective of or correlate to the inventions protected by the claims in this or in continuation/divisional applications hereof.

Moreover, this Summary is not intended to be limiting of the inventions or the claims (whether the currently presented claims or claims of a divisional/continuation application) and should not be interpreted in that manner. While certain embodiments have been described and/or outlined in this Summary, it should be understood that the present inventions are not limited to such embodiments, description and/or outline, nor are the claims limited in such a manner (which should also not be interpreted as being limited by this Summary).

Indeed, many other aspects, inventions and embodiments, which may be different from and/or similar to, the aspects, inventions and embodiments presented in this Summary, will be apparent from the description, illustrations and claims, which follow. In addition, although various features, attributes and advantages have been described in this Summary and/or are apparent in light thereof, it should be understood that such features, attributes and advantages are not required whether in one, some or all of the embodiments of the present inventions and, indeed, need not be present in any of the embodiments of the present inventions.

### BRIEF DESCRIPTION OF THE DRAWINGS

In the course of the detailed description to follow, reference will be made to the attached drawings. These drawings show different aspects of the present inventions and, where appropriate, reference numerals illustrating like structures, components, materials and/or elements in different figures are labeled similarly. It is understood that various combinations of the structures, components, materials and/or elements, other than those specifically shown, are contemplated and are within the scope of the present inventions.

Moreover, there are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations will not be discussed and/or illustrated separately herein.

FIG. 1A is a block diagram representation of an exemplary Light Field Data Acquisition Device;

FIG. 1B is a block diagram representation of an exemplary Light Field Data Acquisition Device including, among other things, post-processing circuitry integrated therein;

FIGS. 1C and 1F are block diagram representations of exemplary Light Field Data acquisition systems including a Light Field Data Acquisition Device and post-processing circuitry;

FIG. 1D is a block diagram representation of an exemplary Light Field Data Acquisition Device including memory (integrated therein) to store Light Field Data;

FIG. 1E is a block diagram representation of an exemplary Light Field Data Acquisition Device including, among other things, post-processing circuitry and memory integrated therein;

FIG. 1G is a block diagram of an exemplary Light Field Data Acquisition Device including optics, a coded aperture, and sensor to record, acquire, sample and/or capture Light Field Data, including memory integrated therein;

FIG. 1H is a block diagram representation of an exemplary Light Field Data Acquisition Device including a plurality of optics and sensors to record, acquire, sample and/or capture Light Field Data, including memory integrated therein;

FIG. 2A is an illustrative diagram representation of certain optical characteristics of an exemplary Light Field Data Acquisition Device including certain focus planes such as a far-focus plane, a physical light field sensor plane, and the close-focus plane;

FIG. 2B is an illustrative diagram representation of an exemplary light field sensor including, among other things, a microlens array and imaging sensor, which may be separated by (or substantially separated by) the focal length of the microlens array, according to at least certain aspects of certain embodiments of the present inventions and/or which may implement certain aspects of certain embodiments of the present inventions;

FIG. 2C is an illustrative diagram representation of the light field sensor plane, which may be disposed at the principal plane of the microlens array, according to at least certain aspects of certain embodiments of the present inventions and/or which may implement certain aspects of certain embodiments of the present inventions;

FIG. 2D is an illustrative diagram representation of an exemplary light field sensor architecture including, among other things, a main lens (representing the optics), a microlens array and an imaging sensor, illustrating two exit pupil locations which provide or result in different locations of the centers of projected lenslets in the microlens array, according to at least certain aspects of certain embodiments of the present inventions and/or which may implement certain aspects of certain embodiments of the present inventions; notably, the positioning the exit pupil at the location corresponding to the Exit Pupil 2 results in larger disk images projected onto the surface of the imaging sensor relative to the location corresponding to the Exit Pupil 1;

FIG. 3A is an illustrative diagram representation of an exemplary light field sensor architecture including, among other things, main lens (representing the optics), a microlens array and an imaging sensor, wherein the exit pupil is recorded and/or stored as a single number that is the distance of the center of the exit pupil from the microlens array (or imaging sensor surface in an alternative embodiment);

FIG. 3B is an illustrative diagram representation of an exemplary light field sensor architecture including, among other things, main lens (representing the optics), a microlens array and an imaging sensor, wherein the exit pupil may be a location (for example, the center of the exit pupil) in three-dimensional space;

FIG. 3C is an illustrative diagram representation of an exemplary light field sensor architecture including, among other things, main lens (representing the optics), a microlens array and an imaging sensor, wherein the exit pupil may be a location and shape (in the illustrative embodiment, the location of the center of the exit pupil and a disk of a specified radius) in three-dimensional space;

FIG. 4 is an illustrative diagram representation of the propagation of an exemplary light ray from the world, though a lens into a light field acquisition device and impinging on the plane of the light field sensor; wherein for a given light ray (represented by a 3D position and 3D direction vector) that enters the acquisition device, the post-processing circuitry/system may calculate or determine how the rays propagate within the acquisition device between the last lens element of the optics and the microlens array of the light field sensor array by “tracing” the light ray through the lens elements of the optics according to the way the ray would physically refract and propagate through each element of the optics based on physical laws given the glass type, curvature and thickness of each lens element of the optics;

FIG. 5 illustrates a magnified view of a set of projected lenslet disks of the microlens array onto the surface of an imaging sensor (or portion thereof); notably, the locations, size and shape of the projected disks are overlayed onto the captured image; determining the centers and sizes of microlens disks may be performed based on the key optical parameters detailed herein;

FIG. 6 illustrates a magnified view of the surface of an exemplary imaging sensor (or portion thereof) highlighting/outlining the radius of projected disks lenslet disks of the microlens array, the spacing between neighboring centers (pitch) of the lenslet disks of the microlens array, X and Y translation offsets and rotation; the X and Y offset values in this exemplary illustration are the spatial distance between the center pixel on the sensor and the center of a central projected microlens disk; and the spacing between neighboring disk centers is the pitch of the projected microlens array. Notably, although the diameter of the projected disks appears approximately the same size in the illustration as the pitch, the numbers are different and may be used for different purposes;

FIGS. 7A and 7B are block diagram representations of exemplary grid architectures of the microlens array, including a hexagonal grid (FIG. 7A) and a square grid (FIG. 7B) wherein the pitch of the lenslets of the array of such architectures is highlighted/outlined in conjunction therewith;

FIGS. 8A-8C are block diagram representations of exemplary grid architectures of the microlens array, including a hexagonal grid (FIG. 8A), a square grid (FIG. 8B) and square and octagonal grid (FIG. 8C); notably, the pattern of the microlens array may be fixed or constant for a predetermined model, series or version of Light Field Data Acquisition Device;

FIG. 9 is a block diagram representation of sensor pixels of a sensor array (of, for example, a light field sensor) wherein the pitch of the pixels of the sensor array of such architecture is highlighted/outlined in conjunction therewith; the pitch of the pixels/sensors of the sensor may be characterized as the distance between the centers of neighboring sensor pixels and such pitch may be fixed or constant for a predetermined model, series or version of Light Field Data Acquisition Device;

FIG. 10 is an illustrative diagram representation of a collimated light source, microlens array, and image sensor to create an image of points of light or small disks of light; in this illustrative embodiment the sensor, at any time in the manufacturing process after the microlens array has been fastened to the sensor, samples the light rays of a collimated light source wherein all the light rays are perpendicular to the surface of the light field sensor;

FIG. 11 is an exemplary illustration of the resulting image provides a grid of points of light or small images of disks, one per lenslet in the microlens array for microlens array to imaging sensor registration; the registration may employ an image of point-lights or small disks (for example, as produced via the architecture of FIGS. 10 and/or 12); the X and Y offsets are these distances from the center of the recorded image to a nearby (for example, the nearest) point of light/small disk image, and the rotation is the difference in angles between the line determined by a row of points of light and the line determined by a row of sensor pixels;

FIG. 12 is an illustrative diagram representation of an aperture, microlens array and image sensor for registration of the microlens array to the image sensor wherein the small aperture provides a near-uniform light source; an image may be captured from the fully or near fully assembled light field acquisition device of uniform or near uniform field of light (for example, a white wall) when the acquisition device is “stopped down” (i.e. has its optical lens aperture reduced in size) to the minimum available aperture; notably the resulting image will be a grid of points of light or small images of disks, one per lenslet in the microlens array; the X and Y offsets are this distances from the center of the recorded image to a nearby (for example, the nearest) point of light/small disk image, and the rotation is the difference in angles between the line determined by a row of points of light and the line determined by a row of sensor pixels (See, FIG. 11);

FIGS. 13A and 13B are block diagram representations of an exemplary Light Field Data Acquisition Devices including, among other things, sensor (for example, linear or rotary potentiometers, encoders and/or piezo-electric or MEMS transducers, and/or image sensors such as CCDs or CMOS—notably, any sensor whether now known or later developed is intended to fall within the scope of the present inventions) to sense, detect and/or determine (i) the configuration of the lens system of the acquisition device, and/or (ii) determine the Exit Pupil or Aperture Function of the lens system of the Light Field Data Acquisition Device relative to the microlens array (for example, one or more of the size and/or shape and/or other characteristics of the Exit Pupil (relative to the microlens array); notably, the sensors may be employed in any of the acquisition devices described and/or illustrated herein, including those of FIGS. 1A-1H—for the sake of conciseness, such sensors will not be illustrated therewith;

FIGS. 14A-14C are illustrative diagram representations of a microlens array and image sensor highlighting disks of light projected by a lenslet onto the microlens array; notably, the spacing between neighboring disk centers is the pitch of the projected microlens array; the radius of each projected lenslet disk may be considered extent of the disk of light projected by a lenslet in the microlens array, wherein (i) the size of projected disks may be smaller than spacing between disks (FIG. 14A), (ii) the size of projected disks may be nearly the same as the spacing between disks (FIG. 14B), and (iii) the size of projected disks may be larger than spacing between disks (FIG. 14C);

FIGS. 15A and 15B are block diagram representations of exemplary electronic light field data files having one or more sets of Light Field Data, according to at least certain aspects of certain embodiments of the present inventions and/or which may implement certain aspects of certain embodiments of the present inventions, wherein the file format or structure of the Light Field Data file may include a start code and/or end code to indicate the beginning and/or end, respectively, of a set of a Light Field Data; notably, the electronic data file format or structure may have a header section containing metadata which may include and/or consist of Light Field Configuration Data (see, FIG. 15B);

FIG. 15C is a bock diagram of exemplary electronic file having Light Field Configuration Data which is associated with one or more electronic light field data files having one or more sets of Light Field Data, according to at least certain aspects of certain embodiments of the present inventions and/or which may implement certain aspects of certain embodiments of the present inventions;

FIGS. 16A and 16B are block diagram representations of memory (which may store, among other things, the electronic data files having one or more sets of Light Field Data) in communication with post-processing circuitry, according to at least certain aspects of certain embodiments of the present inventions and/or which may implement certain aspects of certain embodiments of the present inventions, wherein the memory may be separate from or integrated with the post-processing circuitry (FIGS. 16A and 16B, respectively);

FIGS. 16C and 16D are block diagram representations of exemplary Light Field Data Acquisition Devices, according to at least certain aspects of certain embodiments of the present inventions and/or which may implement certain aspects of certain embodiments of the present inventions, wherein the exemplary Light Field Data Acquisition Devices include a display (Standard Display Mechanism) to allow the user to view an image or video generated using one or more sets of Light Field Data in a Light Field Data File;

FIGS. 16E and 16F are block diagram representations of exemplary Light Field Data Acquisition Devices, according to at least certain aspects of certain embodiments of the present inventions and/or which may implement certain embodiments of the present inventions, wherein the Light Field Data Acquisition Device couples to external systems/devices (for example, external storage, video display, printer, recording device and/or processor circuitry) including an external display to allow the user to view an image or video generated using one or more sets of Light Field Data in a Light Field Data File; such external devices or circuitry may facilitate, for example, storage of electronic data files that include light field image data, electronic files that include Light Field Configuration Data and/or electronic files that include a combination thereof;

FIG. 16G is a block diagram representation of memory (which may store the electronic data files having one or more sets of Light Field Data and/or Light Field Configuration Data) in communication with post-processing circuitry, according to at least certain aspects of certain embodiments of the present inventions and/or which may implement certain aspects of certain embodiments of the present inventions, wherein the post-processing circuitry includes write circuitry and read circuitry to communicate with the memory, and the processing circuitry to implement, for example, Light Field Processing that includes generating, manipulating and/or editing (for example, adjusting, selecting, defining and/or redefining the focus and/or depth of field) the image data corresponding to the Light Field Data—after acquisition or recording thereof;

FIG. 17A is a block diagram representation of exemplary electronic data files having a image data (which is representative of an image) arranged, organized and/or stored in a Standard Image Format, as defined in the Detailed Description, and one or more sets of Light Field Data, according to at least certain aspects of certain embodiments of the present inventions and/or which may implement certain embodiments of the present inventions;

FIGS. 17B-17D are block diagram representations of exemplary electronic data files having image data (which is representative of an image) arranged, organized and/or stored in a Standard Image Format and one or more sets of Light Field Data, according to at least certain aspects of certain embodiments of the present inventions and/or which may implement certain embodiments of the present inventions, wherein such electronic data files may include one or more headers having metadata which includes, for example, one or more sets of Light Field Configuration Data;

FIGS. 17E and 17F are block diagram representations of exemplary electronic data files having image data (which is representative of an image) arranged, organized and/or stored in a Standard Image Format and one or more sets of “raw” image data, according to at least certain aspects of certain embodiments of the present inventions and/or which may implement certain embodiments of the present inventions, wherein such electronic data files may include one or more headers having metadata;

FIGS. 18A-18E are exemplary processing flows for post-processing the exemplary electronic data files having data (for example, one or more sets of Light Field Data), according to at least certain aspects of certain embodiments of the present inventions and/or which may implement certain aspects of certain embodiments of the present inventions, wherein the exemplary post-processing flows may be employed in conjunction with the electronic data files of FIGS. 17A-17F;

FIG. 19 is a block diagram representation of exemplary electronic data files in conjunction with exemplary processing flows for post-processing data contained therein, according to at least certain aspects of certain embodiments of the present inventions and/or which may implement certain embodiments of the present inventions, wherein such electronic data files include image data (which is representative of an image) arranged, organized and/or stored in a Standard Image Format and one or more sets of Light Field Data, and the processing may utilize any Standard Display Mechanism to view the Standard Image portion of the electronic data file; notably, such electronic files may include one or more headers (not illustrated) having metadata (which includes, for example, one or more sets of Light Field Configuration Data); moreover, in the processing flows; and

FIG. 20 is a block diagram representation of an exemplary user interface of, for example, the Light Field Data Acquisition Device and/or post-processing system, according to certain aspects of the present invention; notably, in one embodiment, the user interface may include an output device/mechanism (for example, display and/or speaker) and/or user input device/mechanism (for example, buttons, switches, touch screens, pointing device (for example, mouse or trackball) and/or microphone) to allow a user/operator to monitor, control and/or program the operation of the Light Field Data Acquisition Devices and/or post-processing circuitry/system.

Again, there are many inventions described and illustrated herein. The present inventions are neither limited to any single aspect nor embodiment thereof, nor to any combinations and/or permutations of such aspects and/or embodiments. Each of the aspects of the present inventions, and/or embodiments thereof, may be employed alone or in combination with one or more of the other aspects of the present inventions and/or embodiments thereof. For the sake of brevity, many of those combinations and permutations are not discussed separately herein.

### DETAILED DESCRIPTION

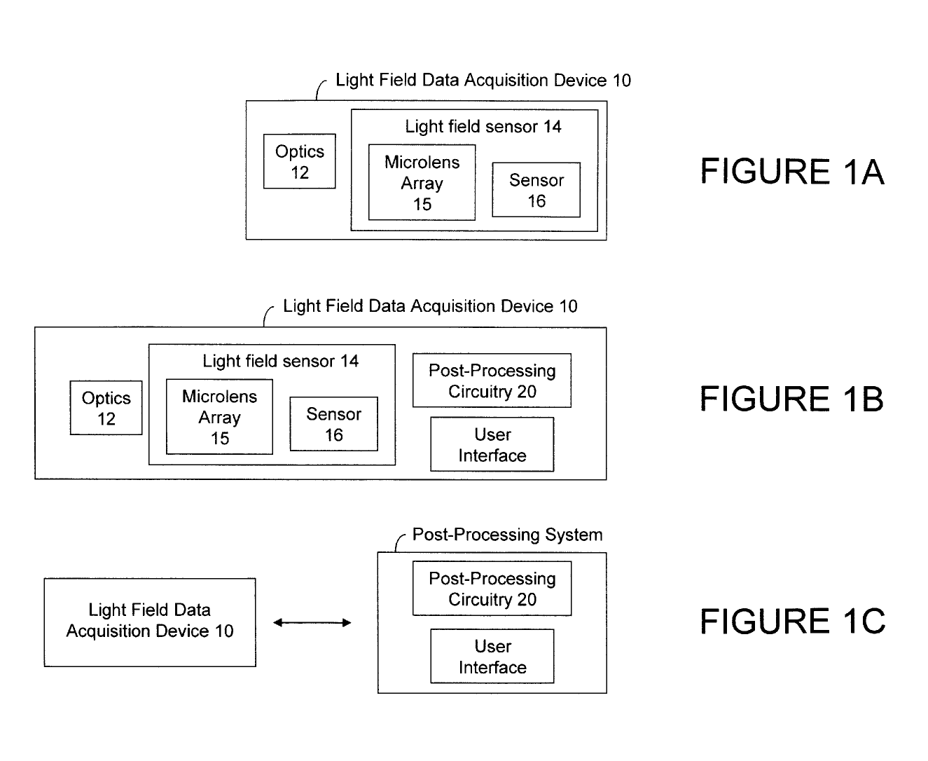

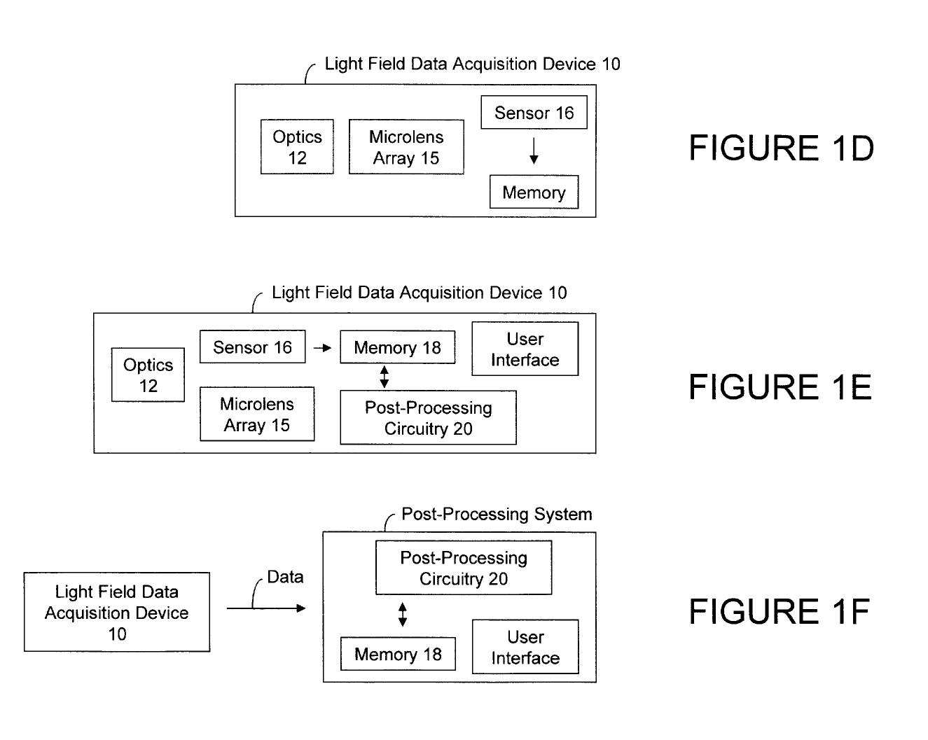

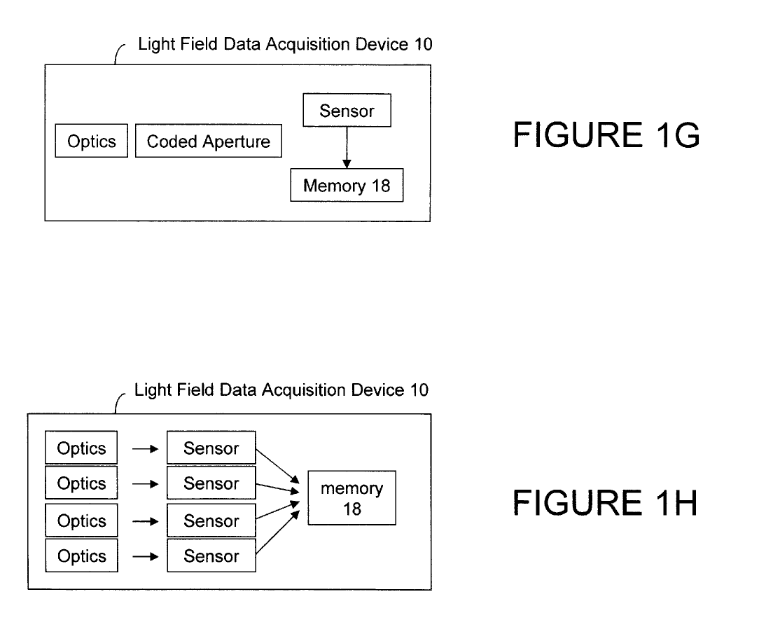

There are many inventions described and illustrated herein, as well as many aspects and embodiments of those inventions. In one aspect, the present inventions are directed to, among other things, Light Field Data Acquisition Devices (for example, light field cameras), post-processing systems relating thereto, and methods of using such devices and systems. In another aspect, the present inventions are directed to obtaining, deriving, calculating, estimating, determining, storing and/or recording one or more characteristics, parameters and/or configurations of a Light Field Data Acquisition Device used to implement post-processing of the image data captured or acquired thereby (or example, adjust, select, define and/or redefine the focus and/or depth of field—after initial acquisition and/or recording of the image data). In yet another aspect, the present inventions are directed to transmitting, providing or communicating such characteristics, parameters and/or configurations to post-processing circuitry—whether such post-processing circuitry is disposed in/on the Light Field Data Acquisition Device (see FIGS. 1B and 1E) or external thereto (see FIGS. 1C and 1F). The data which is representative of the characteristics, parameters and/or configurations (collectively “configuration data”) of the Light Field Data Acquisition Device may be obtained, determined and/or recorded before, during and/or after collection or acquisition of Light Field Data by the imaging sensor of the acquisition device (for example, light field camera).

Notably, such configuration data may be employed by post-processing circuitry to generate, derive, calculate, estimate and/or determine an optical and/or geometric model of the Light Field Data Acquisition Device (for example, an optical and/or geometric model of the particular device which is associated with specific acquired Light Field Data). The post-processing circuitry may employ the optical and/or geometric model of the Light Field Data Acquisition Device to generate, manipulate and/or edit (for example, define and/or redefine the focus of the light field image data) the light field image data which is associated with or corresponds to the optical and/or geometric model of the Light Field Data Acquisition Device employed to acquire or collect such Light Field Data.

DEFINITIONS: The inventions described in this detailed description are introduced in terms of exemplary embodiments that are in some cases discussed in terms of the following terms.

Light Field Data means, among other things, a set of values, where each value represents the light traveling along each geometric light ray (or bundle of rays approximating a geometric light ray) within a corresponding set of light rays. In an exemplary embodiment, Light Field Data represents the 2D image data sampled by and read from the image sensor pixel array in a light field acquisition device (for example, a light field camera comprising a main lens, microlens array and a photo sensor, such as the one shown in United States Patent Application Publication 2007/0252074, and/or the provisional application to which it claims priority, and/or Ren Ng's PhD dissertation, “Digital Light Field Photography”, Stanford University 2006, all of which are incorporated here in their entirety by reference; and/or the block diagram illustration of a light field camera in FIGS. 1A and 1B). The Light Field Data may be represented as a function L(x,y,u,v) where L is the amount of light (for example, radiance) traveling along a ray (x,y,u,v) that passes through the optical aperture of the camera lens at 2D position (u,v) and the sensor at 2D position (x,y)—see, for example, the Patent Application Publication 2007/0252074 and PhD dissertation mentioned above. In addition, Light Field Data may mean the image data collected with a coded aperture system. (See FIG. 1G) and/or data encoded and/or recorded in the frequency spectrum of the light field. Indeed, Light Field Data may be a collection of images focused at different depths and/or a collection of images from different viewpoints. (See FIG. 1H). Notably, Light Field Data may mean any collection of images or lighting data that may be used to generate, derive, calculate, estimate and/or determine a full or partial representation or approximation of a light field function L(x,y,u,v) as described above.

Light Field Configuration Data means data that may be used to interpret (in whole or in part) Light Field Data. For example, Light Field Configuration Data are data that may be used to interpret how the values in the Light Field Data relate to or map the characteristics of light flowing on particular light rays or sets of light rays in the scene pertaining to the light field. Such characteristics may include or depend upon, for example, the intensity, color, wavelength, polarization, etc. of the light in the scene. The Light Field Configuration Data may be representative of and/or used in generating, deriving, calculating, estimating and/or determining an optical and/or a geometric model of the image data acquisition device (for example, an optical and/or a geometric model of the image data acquisition device that is associated with certain acquired Light Field Data). Light Field Configuration Data may include one, some or all of the following, and/or data representative of and/or used in generating, deriving, calculating, estimating and/or determining one, some or all of the following:
One or more characteristics, parameters and/or configurations of a Light Field Data Acquisition Device
A geometric and/or optical model of the Light Field Data Acquisition Device, that may, for example, be sufficient to enable computation, estimation, determination, representation of how light rays optically propagate (for example, refract, reflect, attenuate, scatter and/or disperse) through the acquisition device. The geometric and/or optical model may be and/or include data which is representative of a mapping from a two-dimensional (x,y) position on the surface of an image sensor in the Light Field Data Acquisition Device to a four-dimensional (x,y,u,v) parameterization of a ray, as described above, in the light field), and correspondingly, from the two-dimensional (x′,y′) position on a captured 2D array of pixel values read from the image sensor, to the four-dimensional (x,y,u,v) parameterization of the light field from the scene.
An Aperture Function, as described below.
An Exit Pupil, as described below.
The relative pitch of microlenses and pixels in a light field camera used to record a light field.
The zoom and/or focus position of the lens system
Characteristics, properties, the geometry of and/or parameters of the microlens array (for example, the grid pattern, lens size, focal range, and/or lens formulae of the microlens array).
The location of the microlens array relative to the imaging sensor (for example, the vertical separation, X and Y offsets, and/or rotation of the microlens array relative to the sensor).
The characteristics, properties, geometry of and/or parameters of the images that appear on the imaging sensor by light passing from the world through the microlens array onto the imaging sensor surface (for example, in some embodiments the pattern, separation, X and Y offsets, and/or rotation of the array of image disks that appear on the imaging sensor surface)
The main lens system (for example, lens formulae, f/number, and/or data representing the Exit Pupil).
A Ray Correction Function (see, e.g., Ren Ng's PhD thesis referenced above) that maps (possibly aberrated) rays within the acquisition device to world rays.

Notably, Light Field Configuration Data is not limited to any single aspect or embodiment thereof, nor to any combinations and/or permutations of such aspects and/or embodiments. Indeed, in some exemplary embodiments, Light Field Configuration Data may encompass any information now known or later developed which is representative of and/or used in generating, deriving, calculating, estimating and/or determining an optical and/or a geometric model of the Light Field Data Acquisition Device.

Aperture Function is a term for data that relates to and/or represents the transfer of light through an optical system. In an exemplary embodiment, Aperture Function is a function that specifies for geometric light rays striking a sensor, how much light passes from the outside of the acquisition device, through the lens (or plurality of lenses) and strikes the sensor along that ray trajectory. The Aperture Function may be represented by a 4D function, A(x,y,u,v), where A represents the fraction of light transferred through the lens (or plurality of lenses) along a ray (x,y,u,v) that strikes the sensor at 2D position (x,y) and from a direction (u,v) on the hemisphere of incoming directions. Notably, other embodiments using alternative parameterizations of the rays that strike the sensor are included in the present inventions. Notably, the Aperture Function corresponding to such a function may be represented or approximated by an Exit Pupil, as described below.
Exit Pupil is term for data relating to or representing the optical exit pupil of a lens system that may be used to describe, generate, represent, construct and/or reconstruct a model and/or function of the optical exit pupil. Exit Pupil may also mean an actual or approximate representation of the optical exit pupil including one, some or all of its size, shape and/or 3D position. For example, the Exit Pupil may be represented as a disk of specified radius, at a specific perpendicular distance relative to a sensor plane and/or microlens array. In other exemplary embodiments, Exit Pupil is a representation where the shape and/or distance and/or 3D position varies depending on the position on the sensor from which the Exit Pupil is viewed. The data representing the Exit Pupil may be a compact parameter or set of parameters.

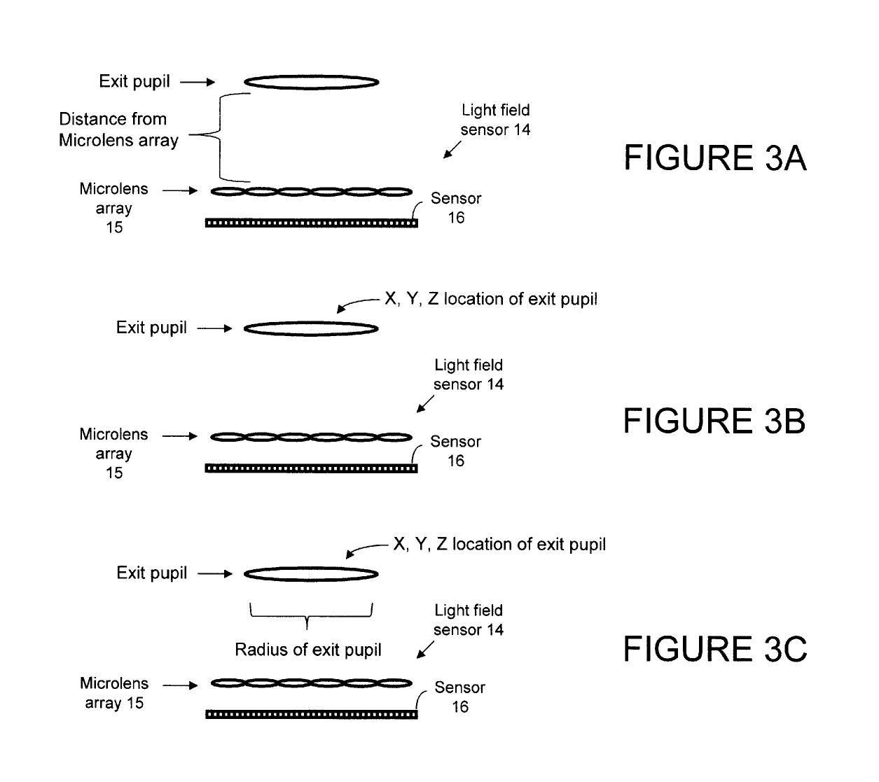

In one exemplary embodiment, data representing the Exit Pupil is recorded and/or stored as a single number that is the distance of the center of the exit pupil from the microlens array or imaging sensor surface (see FIG. 3A). In another embodiment, data representing the Exit Pupil may be a location (for example, the center of the exit pupil) in 3 dimensional space (see FIG. 3B). In another exemplary embodiment, data representing the Exit Pupil may be a location and shape (for example, the location of the center of the exit pupil and a disk of a specified radius) in 3 dimensional space (see FIG. 3C). Notably, data representing the Exit Pupil may be recorded and/or stored in many different forms, and data representing the Exit Pupil is not limited to any single aspect or embodiment thereof, nor to any combinations and/or permutations of such aspects and/or embodiments. Indeed, data representing the Exit Pupil may be in any form now known or later developed.

The terms Aperture Function and Exit Pupil may be used synonymously herein.

Light Field Processing means processing Light Field Data to, for example, compute an output result, for example, an image. In certain aspects of the present inventions, Light Field Processing encompasses generating, manipulating and/or editing (for example, adjusting, selecting, defining and/or redefining the focus and/or depth of field relative to the relative to focus and/or depth of field provided by the optics of the acquisition device during acquisition, sampling and/or capture of the Light Field Data) the image data corresponding to the Light Field Data—after acquisition or recording thereof. Light Field Processing may use Light Field Configuration Data in interpreting Light Field Data in order to implement a particular processing to produce a particular output result. Different types of Light Field Processing may be used in different embodiments of the present invention. In one exemplary embodiment, Light Field Processing may include refocusing—that is, processing the Light Field Data to compute an image in which at least part of the image is refocused (relative to the optical focus of the acquisition system) at a desired or virtual focus plane in the scene. In another exemplary embodiment, Light Field Processing may include aberration correction, in which the light rays in the light field are processed in order to reduce the effects of optical aberration in the optical system used to record the Light Field Data. In exemplary embodiments, such aberration correction is implemented according to the methods of processing L(x,y,u,v) light field functions with the geometric and/or optical model of the Light Field Data Acquisition Device as shown in U.S. patent application Ser. No. 12/278,708 filed on Aug. 7, 2008 and entitled “Correction of Optical Aberrations”, which is incorporated in its entirety herein by reference, and/or Ren Ng's PhD dissertation, “Digital Light Field Photography”, Stanford University 2006. In another exemplary embodiment, Light Field Processing may include changing (increasing or decreasing) the depth field, in which the light rays are processed in order to compute an image in which the depth of field is changed (increased or decreased) to, for example, provide a different range of depths in the world into focus or a predetermined focus. These examples are not intended to limit the scope or types of processing associated with Light Field Processing in the description of embodiments below.

As noted above, Light Field Processing may include processing to correct for inherent lens aberrations in the recorded Light Field Data—after initial acquisition or recording of the Light Field Data and/or information—of, for example, a scene. In another exemplary embodiment, Light Field Processing includes simulating novel lens systems—after initial acquisition or recording of the Light Field Data and/or information) of, for example, a scene. In another exemplary embodiment, Light Field Processing includes changing the viewing perspective—after initial acquisition or recording of the Light Field Data and/or information—of, for example, a scene. In another exemplary embodiment, Light Field Processing includes creating holographic images from Light Field Data—after initial acquisition or recording of the Light Field Data and/or information—of, for example, a scene. Notably, Light Field Processing is not limited to any single aspect or embodiment thereof, nor to any combinations and/or permutations of such aspects and/or embodiments. Indeed, Light Field Processing encompasses any act of act of generating, manipulating, editing and/or processing Light Field Data now known or later developed.

Standard Image Format is a term used to denote images or image data arranged, organized and/or stored (hereinafter, in this context, “stored”) in a standard encoding for storage, display or transmission. Exemplary embodiments include JPEG, EXIF, BMP, PNG, PDF, TIFF and/or HD Photo data formats.

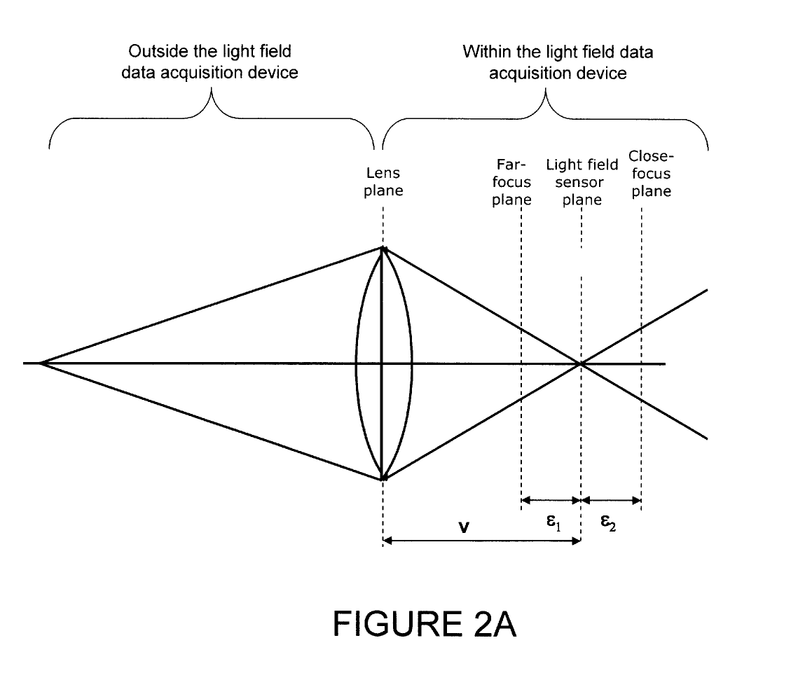

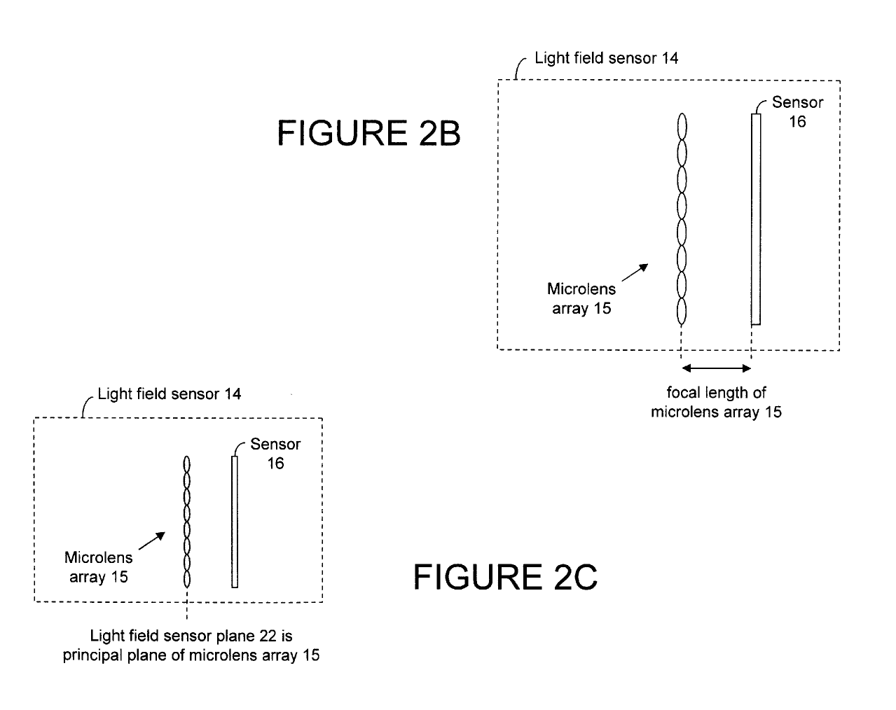

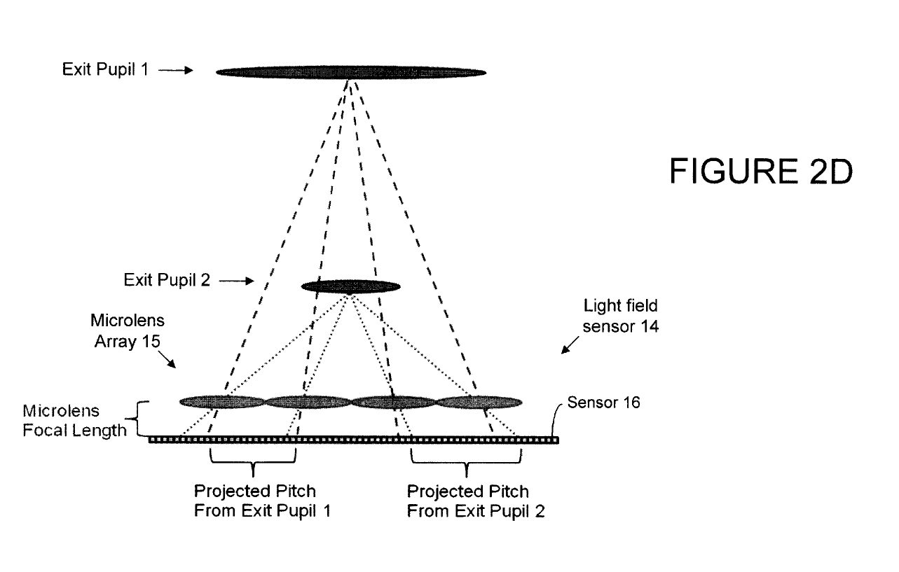

Light Field Data Acquisition Device means any device or system for acquiring, recording, measuring, estimating, determining and/or computing Light Field Data. Briefly, with reference to FIGS. 1A-1F, 2B and 2C, the Light Field Data Acquisition Device (in exemplary embodiments illustrated as light field data acquisition device 10) may include optics 12 (including, for example, a main lens), light field sensor 14 including microlens array 15 and sensor 16 (for example, a photo sensor). The microlens array 15 is incorporated into the optical path to facilitate acquisition, capture, sampling of, recording and/or obtaining Light Field Data via sensor 16. Such Light Field Data may be stored in memory 18. Notably, the discussions set forth in United States Patent Application Publication 2007/0252074, the provisional applications to which it claims priority (namely, U.S. Provisional Patent Application Ser. Nos. 60/615,179 and 60/647,492), and Ren Ng's PhD dissertation, “Digital Light Field Photography”) for acquiring Light Field Data are incorporated herein by reference.

The light field data acquisition device 10 may also include control circuitry to manage or control (automatically or in response to user inputs) the acquisition, sampling, capture, recording and/or obtaining of Light Field Data. The light field data acquisition device 10 may store the Light Field Data (for example, output by sensor 16) in external data storage and/or in on-system data storage. All permutations and combinations of data storage formats of the Light Field Data and/or a representation thereof are intended to fall within the scope of the present inventions.

Notably, light field data acquisition device 10 of the present inventions may be a stand-alone acquisition system/device (see, FIGS. 1A, 1C, 1D and 1F) or may be integrated with post-processing circuitry 20 (see, FIGS. 1B and 1E). That is, light field data acquisition device 10 may be integrated (or substantially integrated) with post-processing circuitry 20 which may perform Light Field Processing (for example, be employed to generate, manipulate and/or edit (for example, adjust, select, define and/or redefine the focus and/or depth of field—after initial acquisition or recording of the Light Field Data) Light Field Image Data and/or information of, for example, a scene); and, in other exemplary embodiments, light field data acquisition device 10 is separate from post-processing circuitry 20. The post-processing circuitry 20 includes processing circuitry (for example, one or more processors, one or more state machines, one or more processors implementing software, one or more gate arrays, programmable gate arrays and/or field programmable gate arrays) to implement or perform Light Field Processing.

Notably, a Light Field Data Acquisition Device, during capture and/or acquisition, may have a light field sensor located such that the “optical depth of field” with respect to the light field sensor does not include the location of a subject. (See, FIG. 2A). The “optical depth of field” may be characterized as depth of field the device would have if used as a conventional imaging device containing a conventional imaging sensor. In this regard, with reference to FIG. 2C, the location of light field sensor plane 22 may be considered the same as the principal plane of the elements in the microlens array 15. Herein, the location of light field sensor plane 22 may be referred to as the location and/or placement of the light field sensor 14 (for example, when describing the location and/or placement relative to other components and/or modules in light field data acquisition device 10 (for example, optics 12)).

The exemplary embodiments of Light Field Data Acquisition Devices above are described to illustrate the underlying principles. Indeed, any device now known or later developed for acquiring, recording, measuring, estimating, determining, and/or computing Light Field Data is intended to fall within the scope of the term Light Field Data Acquisition Device and to fall within the scope of the present inventions.

Recording and Communicating Data: In one aspect, the present inventions are directed to obtaining, deriving, calculating, estimating, determining, storing and/or recording Light Field Configuration Data (for example, one or more characteristics, parameters and/or configurations of a Light Field Data Acquisition Device, for example, the Light Field Data Acquisition Device illustrated in FIGS. 1A-2C). The Light Field Configuration Data may provide information which is representative of an optical and/or a geometric model of the image data acquisition device (which may include, for example, the camera optics (for example, one or more lenses of any kind or type), imaging sensors to obtain and/or acquire the Light Field Data or information, and relative distances between the elements of the image data acquisition device). Indeed, the Light Field Configuration Data may include data which enables or facilitates computation, estimation, determination, representation of how light rays optically propagate (for example, refract, reflect, attenuate, scatter and/or disperse) through the Light Field Data Acquisition Device and to acquisition, capture, sampling of and/or recording by the sensor (for example, sensor 16 of FIGS. 2A-2C).

Thereafter, post-processing circuitry (which may be integrated into the image data acquisition system (see, for example, FIGS. 1A, 1B and 1E) or separate therefrom (see, for example, FIGS. 1C and 1F) may obtain, receive and/or acquire (i) Light Field Data and/or (ii) the Light Field Configuration Data (which may be stored in memory 18). The post-processing circuitry, using the image data and associated Light Field Configuration Data, may determine, analyze and/or interpret the ray-geometry corresponding to one, some or all of imaging sensor pixel values associated with the imaging sensor of the image data acquisition system and thereby perform Light Field Processing (for example, generate, manipulate and/or edit (for example, adjust, select, define and/or redefine the focus and/or depth of field) the image data—after acquisition or recording thereof.)

As noted above, Light Field Configuration Data may be obtained, determined and/or recorded before, during and/or after collection, acquisition and/or sampling of image data by the imaging sensor of the acquisition device (for example, light field acquisition device 10 of FIGS. 1A-2C). Such Light Field Configuration Data may be stored in the same data file and/or file format as the associated image data or in a different data file and/or different file format. Where the post-processing is performed “off-camera” or in a device separate from the acquisition device (for example, light field camera), such Light Field Configuration Data may be provided and/or communicated to a separate post-processing system together with (for example, concurrently, serially or in parallel) or separate from the associated image data (for example, before during and/or after collection, acquisition and/or sampling of image data). (See, for example, FIGS. 1C and 1F).

Thus, in one embodiment, the Light Field Data Acquisition Device and/or post-processing circuitry/system stores, records and/or determines the data or information to construct an optical and/or geometric model of the Light Field Data Acquisition Device. The Light Field Data Acquisition Device and/or post-processing circuitry/system may, in conjunction with the Light Field Data, store, record and/or determine predetermined and/or selected characteristics, parameters and/or configurations of the Light Field Data Acquisition Device. In one embodiment, the Light Field Data Acquisition Device stores or records the predetermined or selected Light Field Configuration Data during, concurrently and/or immediately after collection, acquisition and/or sampling of Light Field Data. The Light Field Data Acquisition Device may store Light Field Configuration Data in, for example, a header of an electronic data file that contains the associated image data. In addition thereto, or in lieu thereof, the Light Field Data Acquisition Device may store the Light Field Configuration Data in, for example, a separate electronic data file which is different from the electronic data file that contains the associated Light Field Data and/or image data. The Light Field Configuration Data may be associated with one or more electronic data files which include the associated Light Field Data and/or image data (i.e., the data which was acquired by the device that was configured in accordance with the data of the associated Light Field Configuration Data).

In an exemplary embodiment, the Light Field Data Acquisition Device determines, records and/or stores Light Field Configuration Data, immediately prior to, concurrently, and/or immediately after certain light field acquisition parameters may change or vary between successive or multiple acquisitions (for example, the zoom and focus position of the optics are determined, acquired, recorded, and/or stored prior to, at the time of acquisition, after acquisition, for example, before one or more of certain parameters of the Light Field Configuration Data change or vary). The Light Field Data Acquisition Device may store the Light Field Configuration Data in, for example, a header of an electronic data file that includes the associated Light Field and/or image data. In addition thereto, or in lieu thereof, the Light Field Data Acquisition Device may store the Light Field Configuration Data in, for example, a separate electronic data file which is different from the data file that contains the associated Light Field and/or image data.

In one embodiment, the post-processing system, using (i) the Light Field Data and/or image data and (ii) associated Light Field Configuration Data, may perform Light Field Processing on (for example, generate, manipulate and/or edit (for example, adjust, select, define and/or redefine the focus and/or depth of field)) the image data—after acquisition or recording thereof—to generate or display a predetermined, selected and/or desired image. In one embodiment, the post-processing system employs the Light Field Configuration Data to construct or re-construct an optical and/or geometric model of the Light Field Data Acquisition Device used to acquire or capture the image data. As noted herein, the post-processing system may obtain the Light Field Configuration Data with or separately from the Light Field Data and/or image data.

Notably, Light Field Configuration Data may include a representation of an optical and/or geometric model for a Light Field Data capture system that includes or provides information to convert or correlate data from an image sensor pixel to a representation of incoming light rays. In one embodiment, the optical and/or geometric model takes as input a location on the imaging sensor (for example, the X and Y offsets of a pixel), and provides a 4 dimensional representation of the set of light rays captured by that pixel location (for example, a set of rays in (x,y,u,v) ray-space as described above. See, for example, United States Patent Application Publication 2007/0252074, and the provisional application to which it claims priority (namely, Ser. Nos. 60/615,179 and 60/647,492, and Ren Ng's PhD dissertation, “Digital Light Field Photography”).

The optical and/or geometric model may include (i) the number, shape (for example curvature and thickness), absolute and/or relative position of the optical elements within the device (including but not necessarily limited to lens elements, mirror elements, microlens array elements, and image sensor elements); (ii) characteristics, parameters, configurations and/or properties of one, some or all of the elements (for example, glass type, index of refraction, Abbe number); (iii) manufacturing tolerances; (iv) measured manufacturing deviations; (v) tilts and/or decenters of optical elements in a lens stack; (vi) coating information, etc. In an exemplary embodiment, the geometric and/or optical model is/are sufficient to enable computation, estimation, determination, representation and/or derivation of the trajectory of at least one light ray that enters the device (for example, enters the first lens element of the device), providing the location and direction of the light ray within the device (for example, within the body of the camera between a lens and a microlens array) and/or the termination position of the ray on the device's image sensor and/or the amount, color and/or dispersion of light propagated through the optics of the system.

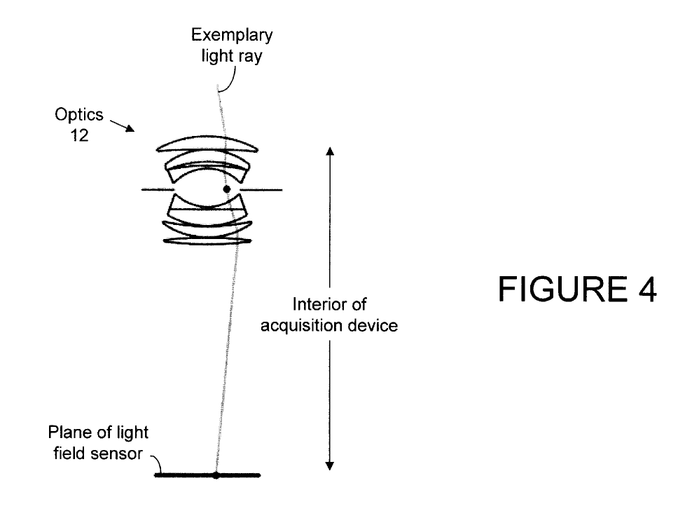

In one exemplary embodiment, the geometric and optical model comprises a representation of one or more (or all) of the following: (i) the curvature and thickness of each lens element, (ii) the spacing and orientation between lens elements, (iii) the type of glass for each element, (iv) the spacing and orientation between the last lens element and the microlens array, (v) the geometric shape of the microlens array, including a hexagonal pattern with given pitch and curvature of lenslets, (vi) the relative spacing and orientation between the microlens array and image sensor array, and (vii) the pitch, pattern and relative orientation of the image sensor array. This geometric and optical model may be used to determine the Ray Transfer Function of the acquisition device according to a computational simulation of the optical effect of the acquisition device on the rays that enter the device. In particular, for a given light ray (represented by a 3D position and 3D direction vector) that enters the acquisition device, the post-processing circuitry/system may calculate the ray that propagates within the body of the acquisition device between the last lens element of the optics and the microlens array of the light field sensor by tracing the ray through the lens elements of the optics according to the way the ray would physically refract and propagate through each element based on physical laws given the glass type, curvature and thickness of each lens element (see, for example, FIG. 4).

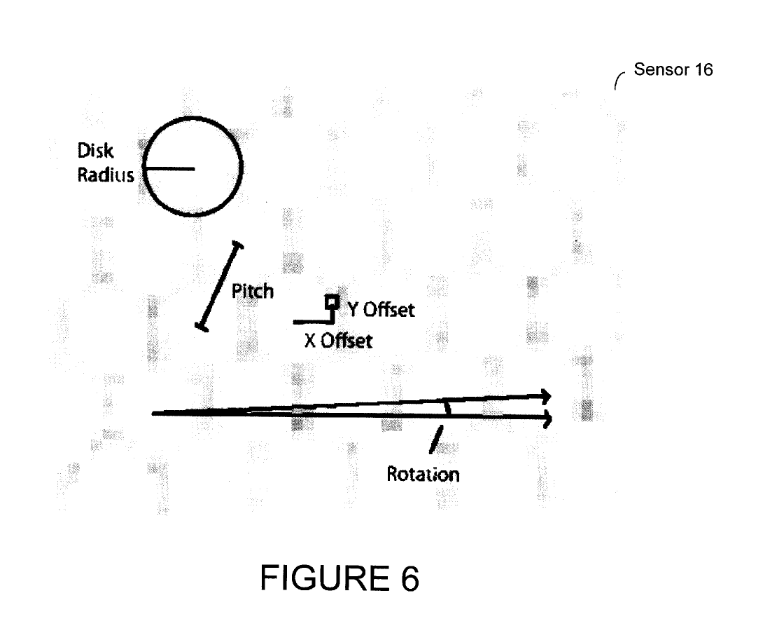

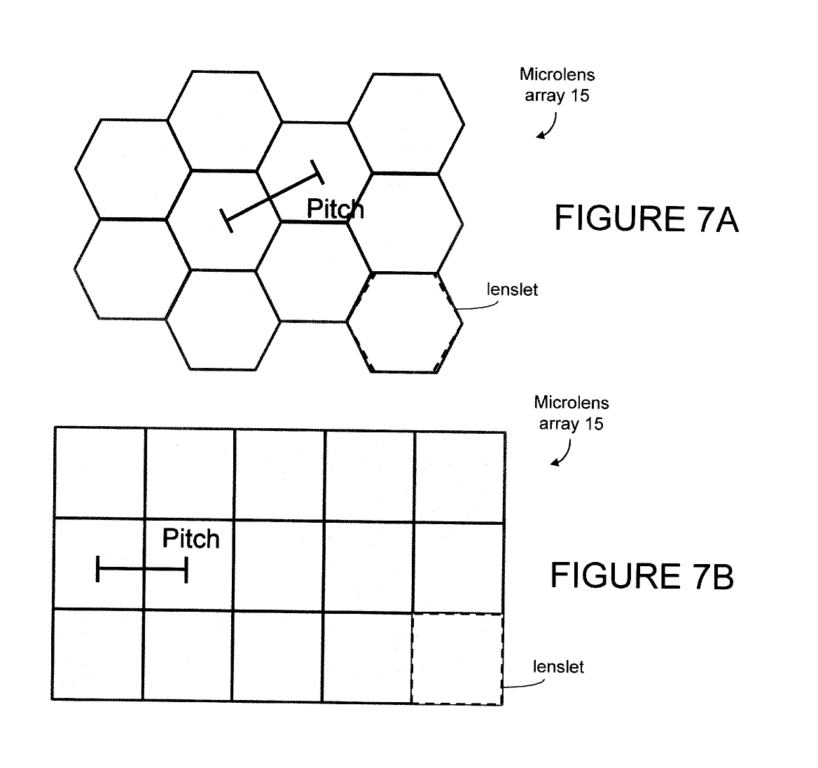

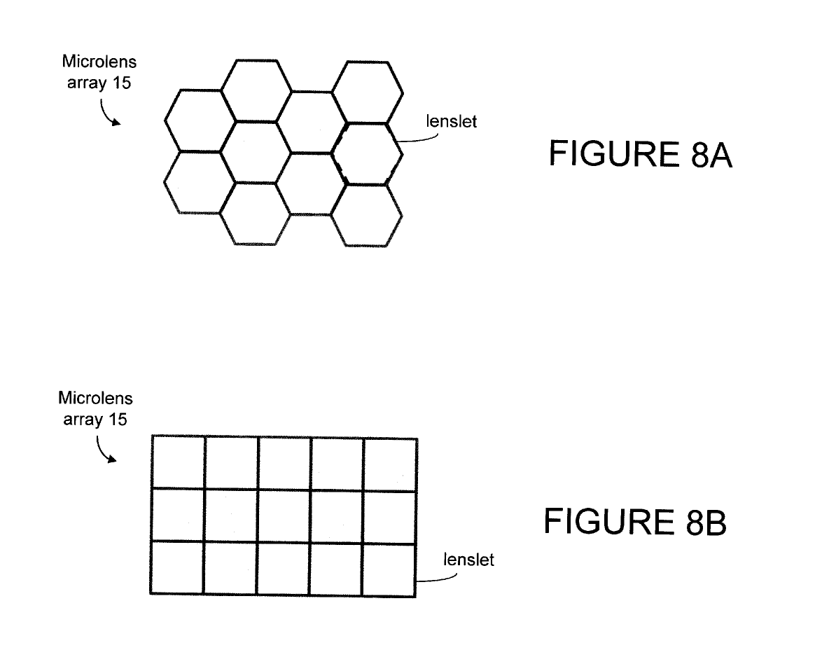

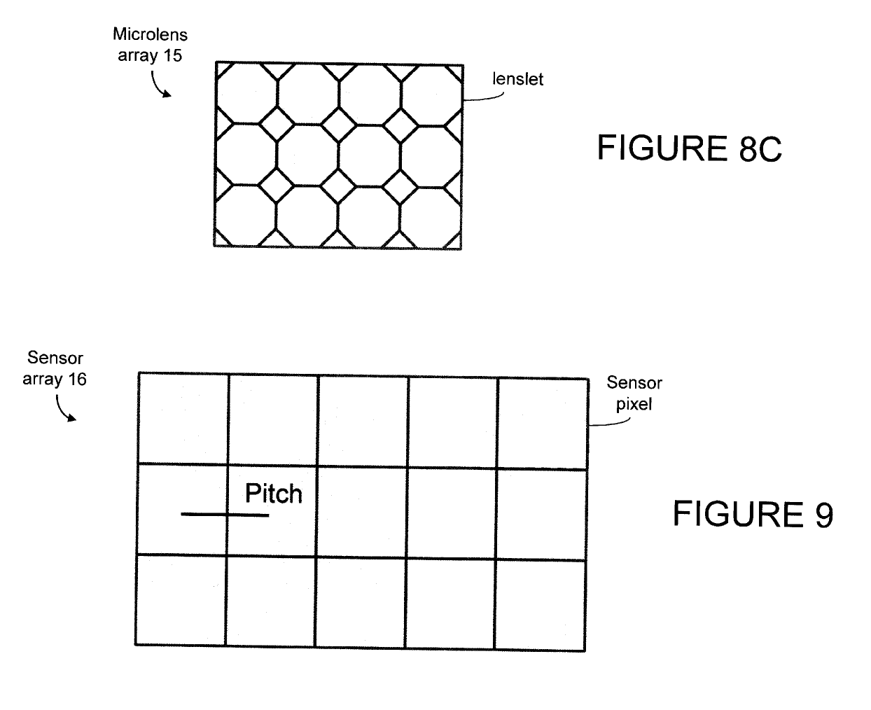

Recording Characteristics, Parameters and/or Configurations of Device: In one exemplary embodiment, one, some or all of the following characteristics, parameters and/or configurations of the Light Field Data Acquisition Device is/are acquired, stored or recorded:
Data or information representing the Aperture Function or Exit Pupil (for example, the size and/or shape and/or 3D position of the optical exit pupil of the optics or lens system) of the Light Field Data Acquisition Device (or data/information which is representative thereof) relative to the microlens array. In one embodiment, the Exit Pupil may vary with each configuration of the lens or optics system of the Light Field Data Acquisition Device. Indeed, the size and/or shape of the Exit Pupil may change on a shot-by-shot basis. (See, FIGS. 2D, 5 and 6); and/or
The Light Field Sensor Geometry Model, which is defined generally as the optical and/or geometric model of the sensor that records Light Field Data. In an exemplary embodiment, the light field sensor includes a microlens array disposed or located in front of an image sensor (See, for example, FIGS. 2A-2C), and the Light Field Sensor Geometry Model may include one, some or all of the following characteristics, parameters and/or configurations:
   The geometry of the microlens array. In the context of the present inventions, “microlens array” is a term that may generally mean any window with a micro-optical patterning. Thus, the geometry of the microlens array would include the surface geometry of the micro-optical patterning; and/or
   The pitch of the lenslets in a microlens array. The pitch of the lenslets in the microlens array may be characterized as the distance between the centers of neighboring microlenses and may be fixed or constant for a predetermined model, series or version of Light Field Data Acquisition Device. In some embodiments, the pitch may be a single number that is constant and valid for all lenslets on the microlens array (See, FIGS. 7A and 7B). In other exemplary embodiments, the pitch may vary based on the spatial location in the microlens array. In other exemplary embodiments, the term “pitch” may be used generally to refer to the pattern of the microlens array, which may be regular, irregular, repeating or non-repeating; and/or
   The distance between the microlens array and the surface of the imaging sensor. In certain embodiments, it may be preferred that this distance is the same as (or substantially the same as) the focal length of the microlens array. (See, FIG. 2D) and/or
   The offsets and rotation of the microlens array relative to the imaging sensor. The relative offsets and rotation of the microlens array may be fixed or constant for a predetermined model, series or version of Light Field Data Acquisition Device or may vary between Light Field Data Acquisition Devices (even between models, versions or pieces thereof). (See, FIG. 6); and/or
   The pattern of the microlens array (for example, hex or square). The pattern of the microlens array may be fixed or constant for a predetermined model, series or version of Light Field Data Acquisition Device. (See, FIGS. 8A, 8B and 8C); and/or
   The pitch of the pixels/sensors of the imaging sensor. The pitch of the pixels/sensors of the sensor (for example, photo sensor array) may be characterized as the distance between the centers of neighboring sensor pixels and may be fixed or constant for a predetermined model, series or version of Light Field Data Acquisition Device. (See, FIG. 9).

As noted above, one, some or all of the Light Field Configuration Data may be determined, stored and/or recorded—and associated with Light Field Data acquired or collected using such exposure characteristics, parameters and/or configurations. While in certain embodiments, all of the exposure characteristics, parameters and/or configurations of the Light Field Data Acquisition Device are employed to perform Light Field Processing (for example, generate, manipulate and/or edit (for example, adjust, select, define and/or redefine the focus and/or depth of field) the image data—after acquisition or recording thereof), less than all may be determined, stored and/or recorded with the associated or corresponding Light Field Data. Accordingly, in certain embodiments, one or more (and, as such, less than all) may be determined, stored and/or recorded for the associated or corresponding Light Field Data. All permutations and combinations of such Light Field Configuration Data (for example, including exposure characteristics, parameters and/or configurations of the Light Field Data Acquisition Device) may be determined, stored and/or recorded with the associated or corresponding Light Field Data. For the sake of brevity, those permutations and combinations will not be discussed separately herein. As such, the present invention is not limited to any single aspect or embodiment thereof nor to any combinations and/or permutations of such aspects and/or embodiments of determining, storing and/or recording such Light Field Configuration Data with the associated or corresponding Light Field Data.

Notably, from the perspective of the imaging sensor, the Aperture Function or Exit Pupil may be characterized in some embodiments as a three dimensional image of the aperture of the main lens. The relative location of the exit pupil on the imaging sensor location may, at least in part, be determined by the optics of the Light Field Data Acquisition Device. As such, the relative location of the exit pupil on the imaging sensor location may depend on, for example, the lens, the zoom, and the focus. (See, for example, FIG. 2D wherein by modifying, adjusting and/or changing the size and location (for example, via zoom) “Exit Pupil 1” projects a first set of rays on the lenslets of the microlens array and “Exit Pupil 2” projects a second set of rays on the lenslets of the microlens array—which impacts the projection of the disks of light from each lenslet onto the surface of the imaging sensor).

Moreover, the size of the projected microlens pitch (for example, the distance between projected lenslet centers on the surface of the imaging sensor, or in other exemplary embodiments the distance across a lenslet along a line between the centers of neighboring lenslets on opposing sides when projected onto) may be characterized or determined using the following relationship:

Projected Pitch=(MLA_Pitch*(D+FLₘ))/D

where:
D is the distance between the sensing array and the exit pupil;
FLₘ is the focal length of the microlens array; and
MLA_Pitch is the lateral separation between centers of neighboring microlenses on the microlens array.

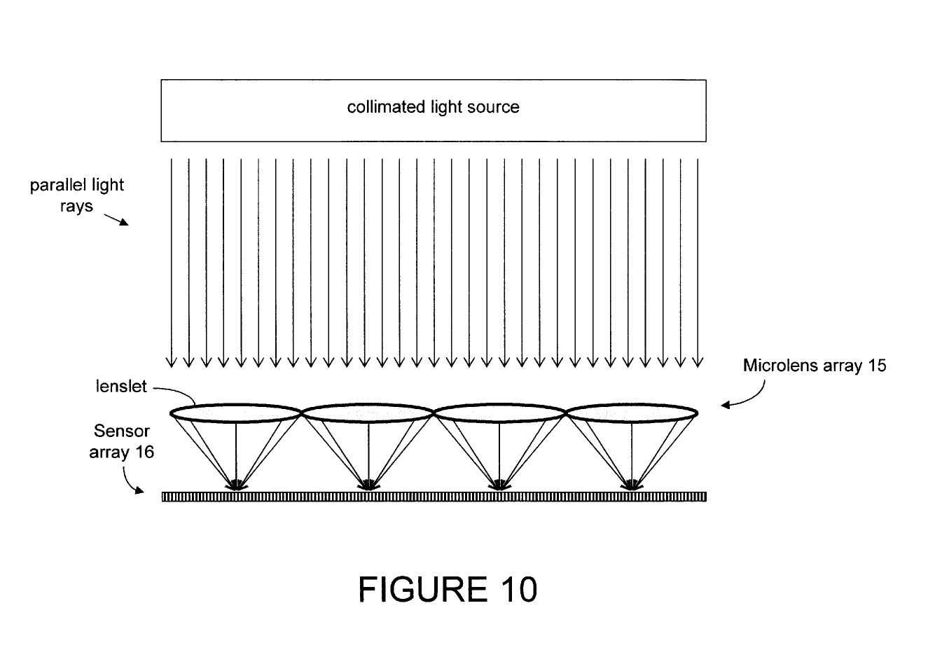

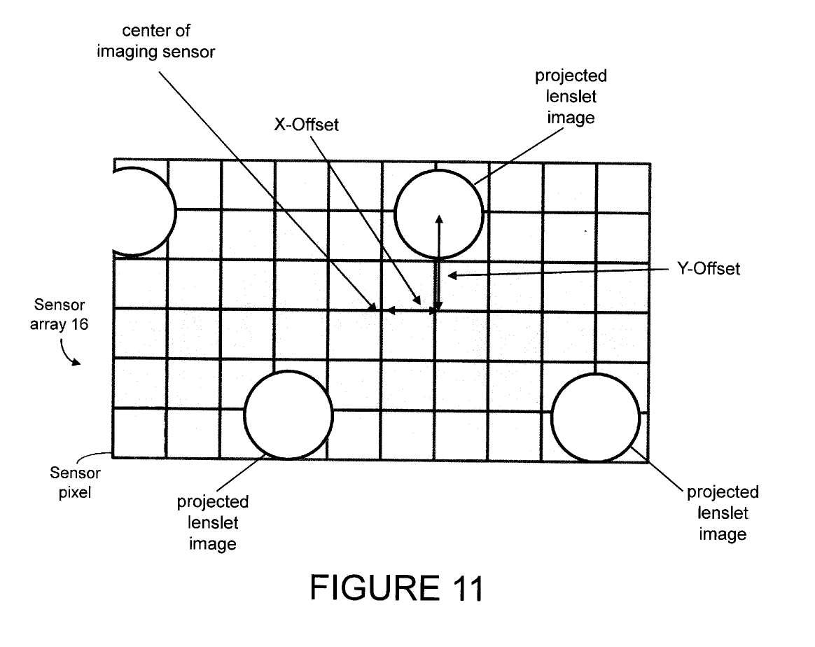

Further, the X-offset, Y-offset, pattern, sensor pixel pitch and rotation of the microlens array relative to the sensor may determine how the disks align with the sensor pixels. The sensor pitch allows the model to map geometric coordinates (generally measured in millimeters or microns) to pixel locations. The sensor pitch and microlens array grid pattern may be known values based on the manufacturing specifications. In one exemplary embodiment, the x-offset, y-offset, and rotation of the microlens array relative to the imaging sensor can be determined through a registration procedure. In one embodiment, an image may be acquired using the combination of the microlens array with the imaging sensor, at any time in the manufacturing process after the microlens array has been fastened to the imaging sensor, of a collimated light source with all light rays perpendicular to the surface of the light field sensor. In this exemplary embodiment, the resulting image will be a grid of points of light or small images of disks, one per lenslet in the microlens array. The X and Y offsets are this distances from the center of the recorded image to a nearby (for example, the nearest) point of light/small disk image, and the rotation is the difference in angles between the line determined by a row of points of light and the line determined by a row of sensor pixels (See FIGS. 10 and 11).

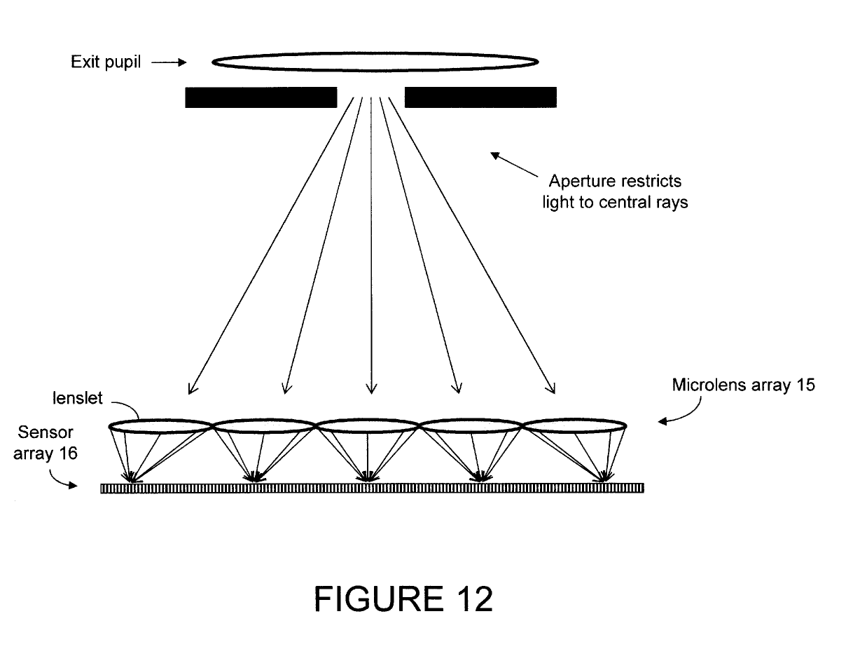

In another exemplary embodiment, an image may be captured from the fully or near fully assembled light field acquisition device of uniform or near uniform field of light (for example, a white wall) when the acquisition device is “stopped down” (i.e. has its optical lens aperture reduced in size) to the minimum available aperture. In this embodiment, the resulting image may be a grid of small disks or points of light, one per lenslet in the microlens array. The X and Y offsets are this distances from the center of the recorded image to the center of a nearby (for example, the nearest) point of light/small disk image, and the rotation is the difference is angles between the line determined by a row of points of light and the line determined by a row of sensor pixels (See FIGS. 11 and 12).

It is important to realize that the preceding descriptions of exemplary embodiments are only intended to illustrate the general principles of measuring, determining, registering and/or calibrating characteristics, parameters, configurations and/or properties of the Light Field Data Acquisition Device for incorporation in Light Field Configuration Data, and any relevant procedures for measuring, determining, registering and/or calibrating that are now known or invented in the future are intended to fall within this aspect of the scope of the present inventions.

In certain embodiments, one of the measured or known values may be left unspecified and other measured or known values may be stored in units relative to the unspecified parameter. For example, in one embodiment the sensor pixel pitch may not be specified and some or all of the distance parameters (for example, the separation of the microlens array from the sensor, the x-offset and y-offset of the microlens array relative to the imaging sensor, and/or the pitch of the microlens array) may then have units that are relative to pitch of the sensor pixels.

In certain embodiments, all of the characteristics, parameters and/or configurations may be employed to model the projection of the microlens disk images onto the sensor surface. This notwithstanding, certain of the characteristics, parameters and/or configurations of the Light Field Data Acquisition Device may be fixed or nearly fixed, constant or nearly constant, predetermined and/or implicit for a given or predetermined model, version or series of Light Field Data Acquisition Device. For example, a lens may be designed such that the Exit Pupil does not vary from picture to picture. As a result, the Exit Pupil may be implicit. Moreover, the placement of the microlens array for a particular device model, version or series may be considered fixed (particularly in those situations where the manufacturing is within certain tolerances) and, as such, these characteristics, parameters and/or configurations may be predetermined or implied. Similarly, the microlens pitch, focal length, sensor pitch, and microlens pattern may also be constant across the focal plane for a particular device model, version or series of a particular model and, as such, these characteristics, parameters and/or configurations may be predetermined or implied.

Notably, the Light Field Configuration Data may for some exemplary embodiments be categorized into three categories. The first of these categories may be referred to as “model static light field configuration data”, and is Light Field Configuration Data that is identical or nearly identical for all light field acquisition devices of a particular model, series or version of a particular model (for example, the pitch of a sensor pixel may be model static). The second of these categories may be referred to as “device static light field configuration data”, and may be Light Field Configuration Data that is fixed or nearly fixed for all light fields acquired by that device (for example, the x-offset, y-offset and rotation of the microlens array relative to the sensor surface may in some instances be device static), excluding model static light field configuration data. The third category may be referred to as “dynamic light field configuration data” and is Light Field Configuration Data that may vary between successive or a plurality of acquisitions from a given or particular Light Field Data Acquisition Device (for example, the zoom and/or optical focus position when acquisition via a given or particular device is performed).

In certain embodiments, those characteristics, parameters and/or configurations of the Light Field Data Acquisition Device which are fixed, constant, predetermined and/or implicit (the model and/or device static light field configuration data) may be determined (i) on an individual basis during and/or after manufacture, (ii) using empirical data of one or more Light Field Data Acquisition Devices, (iii) using statistical approximations, for example, based on one or more empirical data of one or more Light Field Data Acquisition Devices, and/or using computer-based modeling. Indeed, such fixed, constant, predetermined and/or implicit characteristics, parameters and/or configurations of the Light Field Data Acquisition Device may be determined using any technique or device whether now known or later developed.

In addition, data which is representative of such fixed, constant, predetermined and/or implicit characteristics, parameters and/or configurations of the Light Field Data Acquisition Device (the model and/or device static light field configuration data) may be stored in memory in or on the Light Field Data Acquisition Device. In addition thereto, or in lieu thereof, model, version or series of a particular model of the light field acquisition device may be stored in memory and such fixed, constant, predetermined and/or implicit characteristics, parameters and/or configurations of the Light Field Data Acquisition Device (the model and/or device static light field configuration data) may be determined therefrom. As such, in one embodiment, the one, some or all of the fixed, constant, predetermined and/or implicit characteristics, parameters and/or configurations of the Light Field Data Acquisition Device is/are stored or recorded (in the same and/or a different data file) in memory in or on the Light Field Data Acquisition Device. (See, for example, FIGS. 1D and 1E). Thus, the one, some or all of the fixed, constant, predetermined and/or implicit characteristics, parameters and/or configurations of the Light Field Data Acquisition Device (the model and/or device static light field configuration data) may be stored in resident memory, in a data file with the associated or corresponding Light Field Data and/or in a data file which is different from the file of the associated or corresponding Light Field Data.

Such model and/or static light field configuration data may be stored or recorded in memory in or on the Light Field Data Acquisition Device before, during, concurrently with or after exposure (i.e., acquisition or sampling of the Light Field Data). In one embodiment, the model and/or device static light field configuration data may be appended to the associated or corresponding Light Field Data prior to (for example, immediately prior to) communicating the associated or corresponding Light Field Data to a post-processing circuitry/system. In this way, the post-processing system may acquire the data which is representative of such constant, predetermined and/or implicit characteristics, parameters and/or configurations of the Light Field Data Acquisition Device (the model and/or device static light field configuration data) and the associated or corresponding Light Field Data (in the same or different data file)—and generate, manipulate and/or edit one or more images using the Light Field Data (for example, adjust the depth of focus) after acquisition or recording of such Light Field Data.

In another embodiment, one, some or all of the model and/or device static light field configuration data is/are stored in memory in or on the post-processing system. (See, for example, FIG. 1F). In this embodiment, the post-processing system may determine one or more of the constant, predetermined and/or implicit characteristics, parameters and/or configurations of the Light Field Data Acquisition Device based on, for example, data which is representative of the model, version or series of a particular model of the light field acquisition device. Such data which is representative of the model, version or series of a particular model of the light field acquisition device (the model static light field configuration data) may be stored in a data file that is communicated to the post-processing system via the user (for example, via the user interface) and/or via the Light Field Data Acquisition Device (for example, in a data file containing (i) Light Field Data and (ii) the model static light field configuration data, or in a data file which is different from the Light Field Data).

The memory in or on the post-processing system may include a look-up table or the like providing such fixed, constant, predetermined and/or implicit characteristics, parameters and/or configurations of the Light Field Data Acquisition Device. For example, the user may input data, via the user interface, to indicate the fixed, constant, predetermined and/or implicit characteristics, parameters and/or configurations of the Light Field Data Acquisition Device which is associated with the Light Field Data. The post-processing system, in addition thereto or in lieu thereof, may correlate the Light Field Data with the fixed, constant, predetermined and/or implicit characteristics, parameters and/or configurations of the Light Field Data Acquisition Device via data stored in a data file and/or data provided by the Light Field Data Acquisition Device to the post-processing system (for example, in those instances where the Light Field Data Acquisition Device is connected to post-processing system). As noted above, the data which is representative of the fixed, constant, predetermined and/or implicit characteristics, parameters and/or configurations of the Light Field Data Acquisition Device data may be data of the model, version or series of a particular model of the light field acquisition device.

In another embodiment, one, some or all of the model and/or static light field configuration data is/are made available to the post-processing system through a predetermined retrieval system. For example, in one embodiment, the post-processing system may query a database from a local, networked and/or internet source or sources to recover one, some or all of the model and/or static light field configuration data. In another embodiment, the post-processing system may check for and/or install software updates from a local, networked and/or external (for example, Internet) source or sources. Such data which is representative of the model, version or series of a particular model of the light field acquisition device (the model static light field configuration data) may be stored in a data file that is communicated to the post-processing system via the user (for example, via the user interface) and/or via the Light Field Data Acquisition Device (for example, in a data file containing (i) Light Field Data and (ii) the model static light field configuration data, or in a data file which is different from the Light Field Data).

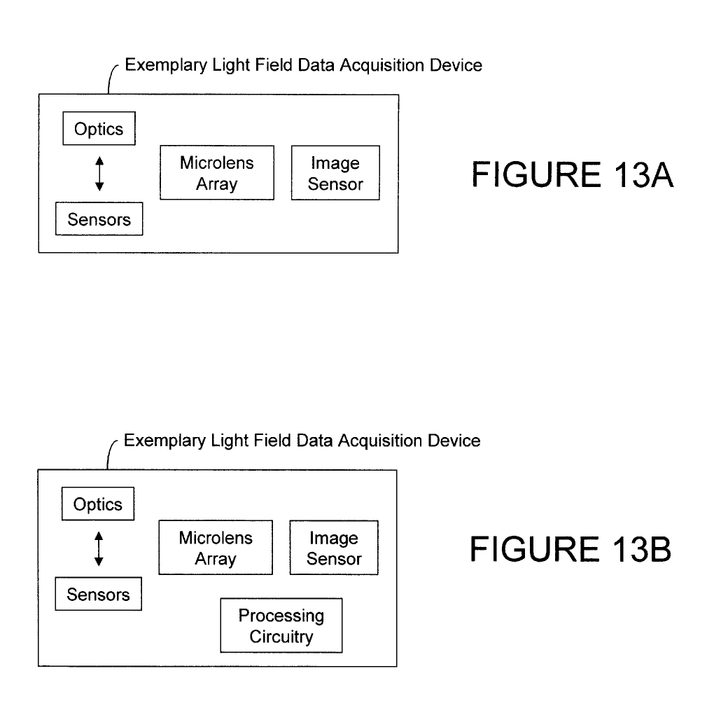

In those instances where the characteristics, parameters and/or configurations of the Light Field Data Acquisition Device are not fixed, constant, predetermined and/or implicit, such characteristics, parameters and/or configurations may be determined using any technique or device whether now known or later developed. For example, in one embodiment, one or more sensors are employed to determine the Exit Pupil or Aperture Function of the lens system of the Light Field Data Acquisition Device relative to the microlens array. In some exemplary embodiment, one or more sensors (for example, linear or rotary potentiometers, encoders and/or piezo-electric or MEMS transducers, and/or image sensors such as CCDs or CMOS—notably, any sensor whether now known or later developed is intended to fall within the scope of the present inventions) may sense, detect and/or determine one or more of the size and/or shape and/or other characteristics of the Exit Pupil (relative to the microlens array) by sensing, detecting and/or determining the configuration of the lens system of the Light Field Data Acquisition Device. (See, for example, FIGS. 13A and 13B).

In one exemplary embodiment, an image sensor array with known microlens array between it and the optical system is used to sense the exit pupil of the optical system. Based on the image signal that appears on the image sensor array, the shape and/or location of the exit pupil is deduced from the separation between the microlens disk images that appear under each microlens. The shape of the exit pupil may be determined by the shape of the individual microlens images (which may overlap)—for example, a circular image indicates a circular exit pupil, a hexagonal image indicates a hexagonal exit pupil and a square image indicates a square exit pupil. In some embodiments, the shape may vary across the image sensor, indicating a change in the shape of the exit pupil from that apparent viewpoint on the sensor. The distance of the exit pupil from the microlens array and sensor may be determined by the pitch (distance between the relative centers) of the microlens images. As shown in FIG. 2D, a smaller pitch indicates a further distance, according to the linear geometric relationship shown in the Figure.

In one particular example, the distance L between the optical exit pupil and the microlens array may be characterized the following equation:

L=F*X/(Y−X)

where:
F is the separation between the microlens array and the sensor;
X is the separation between two given (for example, neighboring) microlens centers (A and B); and
Y is the separation between the centers of microlens images appearing on the image sensor below A and B.

In another exemplary embodiment, a sensor or other mechanism is used to detect, determine, measure, or keep track of the configuration of a zoom lens. For example, a sensor may detect, determine and/or measure the position of a stepper motor used to drive the zoom lens, and this position may be used as an indicator of the zoom lens configuration. In these exemplary embodiments, the configuration of the zoom lens may be combined with a database or table that maps the configuration to a pre-determined exit pupil configuration. In some embodiments, the number of stepper motor positions may be discrete and finite, and an N-bit key may be used to uniquely denote each position, with each N-bit key corresponding to an entry in the database or table that corresponds to the pre-determined exit pupil configuration that relates to the corresponding stepper motor position.

Notably, in those embodiments where the Light Field Data Acquisition Device connects to a post-processing system, such connection may be via wired and/or wireless architectures using any signaling technique now known or later developed. In addition, the configuration data may be provided and/or communicated to a post-processing system together with or separate from the associated Light Field Data using any format now known or later developed. Indeed, the model and/or device static light field configuration data may be provided and/or communicated to a post-processing system together with or separate from dynamic light field configuration data (i.e., characteristics, parameters and/or configurations of the Light Field Data Acquisition Device are not fixed, constant, predetermined and/or implicit). For example, in one embodiment, model and/or device static light field configuration data may be provided and/or communicated to a post-processing system upon initial connection and thereafter dynamic light field configuration data may be communicated to a post-processing system together with or separate from associated Light Field Data. All communication strategies, formats, techniques and/or architectures relating thereto are intended to fall within the scope of the present inventions.

In one embodiment, the Light Field Data Acquisition Device acquires, determines, stores and/or records data which is representative of the Exit Pupil and sensor pitch. In this regard, in one embodiment, the light field acquisition device acquires, determines, stores and/or records data or information pertaining to the lens configuration (for example, zoom position and range) when the Light Field Data is acquired, collected, sampled and/or obtained (i.e., at the time of “exposure” or when the “shot” is taken). Circuitry in the light field acquisition device may calculate, determine and/or estimate the location of the exit pupil using, for example, the lens configuration.

Notably, at a high level, an optical and/or geometric model for a light field capture system may include or provide information to convert or correlate data from an image sensor pixel to a representation of incoming light rays. The post-processing circuitry, having a model to convert or correlate pixel values to the incoming light rays from the light field acquisition device, may perform Light Field Processing (for example, compute images including, for example, images having different focal planes, as well as computing images which correct for, capture or address artifacts). The present inventions, in certain aspects, record, store and/or determine the optical parameters of the main lens system and the light field capture sensor which facilitates determining an optical and/or geometric model of certain aspects of the Light Field Data Acquisition Device.

Once characteristics, parameters and/or configurations of the lens system and the light field sensor are recorded, stored and/or determined, post-processing circuitry may generate an optical and/or geometric model that “maps” or correlates sensor pixels to geometric rays of light or sets of geometric rays.

Under certain circumstances, the Exit Pupil or Aperture Function may be considered a compact parameter of the Light Field Data Acquisition Device that describes or characterizes the lens system (which may include one or more lenses of any kind or type) of the acquisition device. In this way, post-processing circuitry may employ data which is representative of the Exit Pupil or Aperture Function (for example, size and/or shape of the exit pupil in some embodiments) to facilitate and/or allow Light Field Processing, including, for example, focusing or refocusing one or more images at different depths—post-data acquisition or after acquisition of the Light Field Data by the Light Field Data Acquisition Device.

In those instances where the system performs correction of lens system aberrations, a characterization or representation of the lens system and/or Ray Correction Function may be employed. In one exemplary embodiment, the lens system may be characterized or represented by a set of lens formulas that describe the shape, refraction, and/or spacing between each of the lens elements. Such formulas or relationships may describe how light rays are determined to traverse or pass through the optical system before acquisition by the image sensor. Indeed, a characterization or representation of the how light rays will traverse or pass through the optical system facilitates ray-tracing computation of the ray distortion function which may be employed for correction of optical aberrations. (See, for example, Ren Ng's PhD dissertation, “Digital Light Field Photography”, Stanford University 2006, page 135). In another exemplary embodiment, the lens system may be described by formulas and discrete approximation of the Ray Correction Function (or ray distortion function) itself.

In those instances where vignetting of the lens affects light captured on the sensor surface, it may be advantageous to employ techniques and circuitry to correct, reduce, minimize, and/or eliminate vignetting. An example of such vignetting is darkening of photographs towards the corner, due to eclipsing and/or reduction of the area and/or occlusion (for example, due to internal blockages by boundaries of lens elements or by apertures or by other opaque elements within the barrel of the lens) of the exit pupil from oblique views. Light fields captured with some lens systems may encounter artifacts around the edge of the image if the vignetting of the lens system is not characterized and modeled. In one exemplary embodiment, the lens system is characterized, described and/or represented by the exit pupil parameter and a formula that characterizes the eclipsing of the exit pupil based on the pixel location. In this way, vignetting may be corrected, reduced, minimized, and/or eliminated by normalizing by the area of the eclipsed exit pupil at each pixel location.

In one exemplary embodiment, a lookup table or the like may be used to test if rays are subject to vignetting. In one specific embodiment, a binary lookup table, accessed using the “discretized” X, Y, U, and V components of a geometric ray or set of rays may be checked when a system is performing Light Field Processing. If the binary lookup table stores a false or zero value for the geometric ray parameters, the information (for example, a pixel value) associated with that geometric ray may be discarded. In another specific exemplary embodiment, a numeric lookup table with values ranging from 0.0 to 1.0 may be checked when a system is performing Light Field Processing, accessed using the X, Y, U and V components of a geometric ray or set of rays. The information (for example, a pixel value) associated with the geometric ray parameters may be modified and/or adjusted (for example, by adjusting the pixel value to account for the occlusion or by using the lookup up value to normalize the pixel value) when a system is performing Light Field Processing.

The lookup table may be obtained empirically, for example during a calibration step during the manufacture of the Light Field Data Acquisition Device, by using the device to acquire Light Field Data of a pre-determined Light Field (for example, a scene with constant and even (or nearly constant and nearly even) illumination, or otherwise predetermined and known scene or light field), and storing a lookup table of values normalized by dividing for each value in the Light Field Data, the empirically recorded value by the pre-determined scene or light field. In the Light Field Processing aspect of this exemplary embodiment, the lookup table is used during Light Field Processing by normalizing each value in the Light Field Data by scaling it by the inverse of the matching value in the lookup table. For example, for a Light Field Data Acquisition Device with an image sensor, the lookup table may be stored as a normalized sensor image in the Light Field Configuration Data that is supplied to Light Field Processing. During Light Field Processing on a given input Light Field Data set comprising the image sensor values, each value is weighted proportional to the inverse of the corresponding image sensor value in the normalized sensor image (lookup table).

In yet another exemplary embodiment, the lookup table is represented by an analytic function that approximates the normalized sensor image (for example, for compactness, efficiency and/or optimization). For example, the analytic function and/or approximation used may be a stored subset of the sensor image (for example, the values under one microlens) combined with a process or procedure to map or correlate sensor image pixels in other parts of the image to a corresponding location in the stored subset. In one exemplary embodiment, the mapping or correlation process or procedure is to determine the 2D offset from a predetermined location, for example, the center of the closest microlens, and use the value in the stored subset at the same or nearly the same 2D offset from the center of the microlens in the stored subset. Indeed, methods for determining the 2D offset depend on the pattern of the microlens array, and mathematics are discussed below for exemplary embodiments that utilize data in the Light Field Configuration Data regarding the location of centers and radii of the microlens images in the sensor image.

Notably, the preceding descriptions of exemplary embodiments are only intended to illustrate the general principles of measuring, determining, registering and/or calibrating a lookup table-like function for correcting aspects of vignetting or other undesirable characteristics of the Light Field Data Acquisition Device, and for incorporation in Light Field Configuration Data. Any suitable procedures for measuring, determining, registering, calibrating, approximating, representing and/or storing such lookup table functions as part of Light Field Configuration Data, whether now known or later developed, are intended to fall within this aspect of the scope of the present inventions.

Communicating Optical Representation of Characteristics, Parameters and/or Configurations of the Light Field Data Acquisition Device: As noted above, the optical model for converting from recorded pixel data to geometric light ray information may be constructed based on or using one or more of the characteristics, parameters and/or configurations of the Light Field Data Acquisition Device that describe the light field sensor and the main lens system or optical system of the of the Light Field Data Acquisition Device. The model and/or device static light field configuration data, for example, may be stored in memory on the Light Field Data Acquisition Device, for example, non-volatile memory (such as, a ROM-like memory—for example, electrically programmable read-only memory (“EPROM”), electrically erasable programmable read-only memory (“EEPROM”) and/or Flash memory (for example, NOR or NAND)). The data which is representative of such static characteristics, parameters and/or configurations may be written to memory at any time, for example, during the manufacturing process. In certain embodiments, such model and/or device static light field configuration data include the microlens pitch, microlens pattern, and/or sensor pixel pitch. The model and/or device static light field configuration data may also include the spacing between the microlens array and the sensor surface.

Notably, in those embodiments where the Light Field Data Acquisition Device includes a “fixed” lens system (for example, a light field acquisition device may be manufactured with an attached lens system), the size and shape of the exit pupil may be determined based on, for example, zoom and/or focus position of the optical system of the Light Field Data Acquisition Device. The Exit Pupil or Aperture Function presentation, as related to one or more of the zoom and focus positions, may be predetermined and/or stored in memory (in the form of a look-up table, formula, or the like) on the Light Field Data Acquisition Device and/or in memory on an external post-processing system.

Certain device static light field configuration data (for example, offset and rotation of the microlens array relative to the sensor surface) may vary for each individual Light Field Data Acquisition Device. As such, where certain characteristics, parameters and/or configurations of the Light Field Data Acquisition Device vary on a device-by-device basis, such characteristics, parameters and/or configurations may be stored and/or updated during, for example, a registration procedure, after construction of the Light Field Data Acquisition Device. This data or information may be stored in non-volatile memory (for example, SRAM, NOR or NAND Flash or EEPROM) on or in the Light Field Data Acquisition Device, and, indeed, may be set as part of the device calibration process after construction of the acquisition device.

Communication and Storage of Characteristics, Parameters and/or Configurations in an Interchangeable Lens System: In certain embodiments, the Light Field Data Acquisition Device may include one or more interchangeable lenses. In these embodiments, the Light Field Data Acquisition Device may be provided with (for example, by the user via the user interface) and/or detect (for example, via data acquired from the interchangeable lens) details and/or changes to the optical system thereof. In one embodiment, the Light Field Data Acquisition Device retrieves information from the interchangeable lens to determine the characteristics, parameters and/or configurations and/or changes thereto of the optical system. In another embodiment, the user may input, via the user interface, the characteristics, parameters and/or configurations and/or changes thereto of the optical system. Such information may be passed using any communication techniques, circuitry, (electrical or mechanical) interfaces and/or architectures whether now known or later developed.

In certain exemplary embodiments, the interchangeable lens (i.e., the lens which is incorporated into or on the optical system of the Light Field Data Acquisition Device) and/or the Light Field Data Acquisition Device contains a lookup table in memory that correlates or “maps” (i) the zoom and focus of the optical system to (ii) representation of an Exit Pupil (or Aperture Function). This Exit Pupil may be provided to post-processing circuitry (disposed on the Light Field Data Acquisition Device and/or a stand-alone post-processing system) to facilitate and/or enable Light Field Processing. In another embodiment, the Exit Pupil may be determined by a mathematical relationship based on the zoom and focus of the optical system. Notably, in embodiments having a fixed focus or zoom position, the determination of the size and shape of the exit pupil may depend on different parameters (for example, in an embodiment with a fixed zoom position, the exit pupil may vary only with changes in the focus position).

In another exemplary embodiment, a firmware update is applied to the Light Field Data Acquisition Device in the event that an interchangeable lens is incorporated into optical system. This update may be implemented as a “patch” and may be installed by the user or may be installed automatically when the lens is first coupled to the Light Field Data Acquisition Device. The firmware update may provide a mechanism for determining certain optical parameters of the optical or lens system based on information the lens may provide at exposure or Light Field Data collection, acquisition and/or capture. For example, the firmware update may allow the Light Field Data Acquisition Device to look up data representing the Exit Pupil or Aperture Function of the lens based on the configuration of the lens (for example, one or more predetermined zoom and focus positions of the lens).

In yet another embodiment, memory in the Light Field Data Acquisition Device includes data of one or more interchangeable lenses that may be implemented or incorporated into the optical system of the Light Field Data Acquisition Device. In this embodiment, the memory (for example, non-volatile memory) includes data which is representative of the characteristics, parameters and/or configurations of a plurality of interchangeable lenses that may be implemented or incorporated into the optical system of the Light Field Data Acquisition Device. As such, memory resident in the Light Field Data Acquisition Device may contain a lookup table that “maps” (i) the zoom and focus to (ii) data representing the Exit Pupil. In one embodiment, the resident memory includes a plurality of mathematical relationships wherein a selected one of the predetermined mathematical relationships, based on a particular interchangeable lens implemented or incorporated into the optical system of the Light Field Data Acquisition Device, is employed to determine the exit pupil size and/or shape based on, for example, a particular zoom and focus of the optical system.

In one exemplary embodiment, the memory of the Light Field Data Acquisition Device contains a database of all available interchangeable lenses that will fit the body. Each entry may be keyed by information made available to the camera by the lens system. The key may be unique in the form of a lens model number, or unique by a combination of available parameters such as min zoom, max zoom, and f-number. Indeed, this key may be used to lookup a particular or predetermined mathematical relationship for determining the exit pupil size and/or shape—for example, by converting from the current zoom and focus position of the lens to the exit pupil location.

In another exemplary embodiment, when an interchangeable lens is attached to a Light Field Data Acquisition Device, that device may query an external source or sources (for example, an Internet-capable camera may query a networked database) for updates using a wired (for example, a USB cable connection to a local computer) or wireless (for example, a Wi-Fi enabled device) connection. In this embodiment, the Light Field Data Acquisition Device may query the external source or sources the first time, each time or any time an interchangeable lens is attached to the device to check for and/or update data which is representative of the characteristics, parameters and/or configurations of a plurality of interchangeable lens that may be implemented or incorporated into the optical system of the Light Field Data Acquisition Device.

In the preceding discussion, “zoom and focus” are often used as exemplary characteristics of a lens' optical configuration. Wherever “zoom and focus” are used herein in this context, it should be understood that any subset of the characteristics of an optical systems' configuration, and indeed any of the representations of the optical and/or geometric models of the acquisition device, may be substituted in place of zoom and focus characteristics, or in addition thereto, and such substitutions and generalizations are intended to fall within the scope of the present inventions.

Optical Representation of Microlens Array: In certain embodiments, data which is representative of the microlens array may be recorded or stored to allow for images to be processed via post-processing circuitry. Such data may be stored in a separate configuration data file or together with the Light Field Data file. The configuration data file may be associated with one or more files each containing Light Field Data. For example, the configuration data file may be stored in a header of the electronic file that stores the Light Field Data. Alternatively, the configuration data file may be stored in a separate electronic file relative to the electronic file including the associated Light Field Data. Moreover, the electronic file including the configuration data may be associated with and separate from a plurality of electronic files each containing different Light Field Data.

In one exemplary embodiment, the relevant/associated Light Field Configuration Data may be stored in a Standard Image Format, in a header in the Light Field Data file. In this embodiment, the header includes, among other things, Light Field Configuration Data (for example, including data which is representative of the characteristics, parameters and/or configurations of the optical system). Post-processing circuitry in, for example, a stand-alone post-processing system, may read or interpret the header of the data file to facilitate construction of a model to use for processing the associated or corresponding Light Field Data. In this way, the post-processing circuitry may convert or interpret data from the image sensor to perform Light Field Processing, for example, generate, manipulate and/or edit one or more images using the Light Field Data (for example, focusing or refocusing one or more images at different depths—post-data acquisition or after acquisition of the Light Field Data by the Light Field Data Acquisition Device). For example, the post-processing circuitry may convert or interpret Light Field Data from image sensor pixel locations to a representation of incoming light rays.

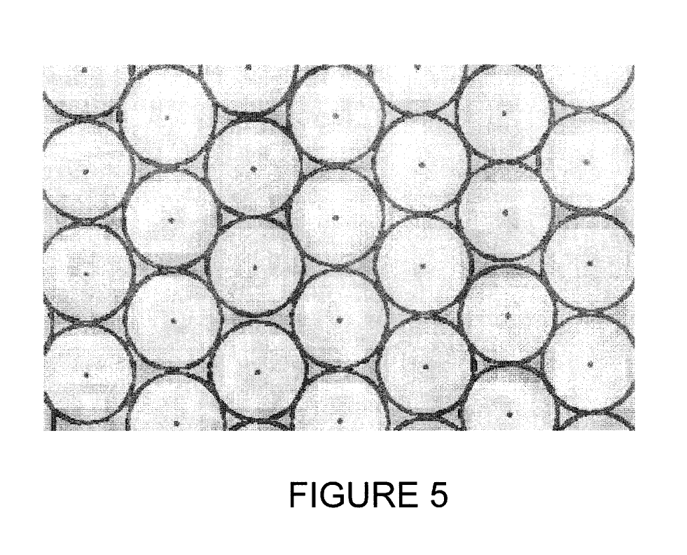

Center Locations and Shapes of Projected Disks: In one embodiment, the system acquires or determines data which is representative of the center locations and sizes of the projected microlens disks on the surface of the imaging sensor. With reference to FIG. 5, the locations, size and shape of the projected disks are overlayed onto the captured image. Information of the locations, size and shapes of the projected image of the lenslets may be employed by post-processing circuitry for Light Field Processing. Indeed, determining the centers and sizes of microlens disks may be determined based on the key optical parameters listed previously, for example using the calculation procedures described in an exemplary embodiment below.

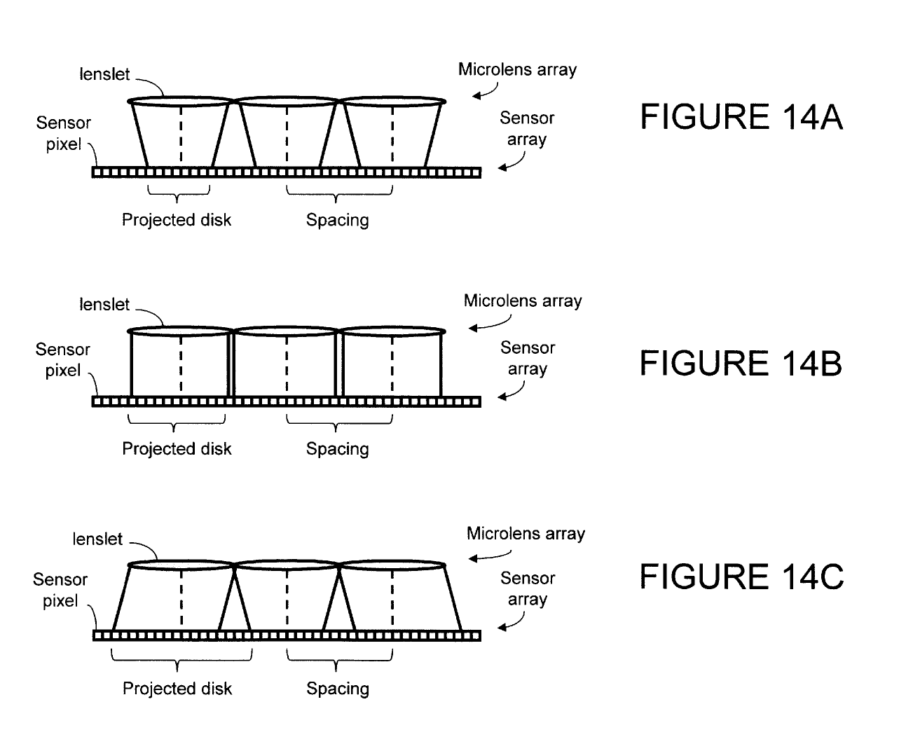

Projected microlens disk locations and shapes: In one embodiment, the system may store or record data which is representative of the (i) X and Y offset of center lenslet projection to the center of the image sensor (or any other offsets to represent translation of microlens array relative to the image sensor), (ii) rotation of microlens array relative to imaging sensor, (iii) microlens grid pattern (for example, hexagonal or square), (iv) radius of the projected lenslets, and/or (v) spacing between neighboring centers of projected lenslets. Such data may be employed by the post-processing circuitry to determine an optical and/or geometric model that may be used for Light Field Processing (for example, focusing or refocusing one or more images at different depths—post-data acquisition or after acquisition of the Light Field Data by the Light Field Data Acquisition Device). (See, for example, FIG. 6). Notably, the X and Y offset values are the spatial distance between the center pixel on the sensor and the center of a central projected microlens disk (in those situations where the microlens include a disk shape). In addition, the spacing between neighboring disk centers is the pitch of the projected microlens array. The radius of each projected lenslet disk may be considered the extent of the disk of light projected by a lenslet in the microlens array (See FIGS. 14A-14C). Note that although the diameter of the projected disks appears approximately the same size in the illustration as the pitch, the numbers are different and are used for differing purposes.

In this embodiment, circuitry may construct a geometric or optical model which converts sensor locations (for example, the X and Y location of pixel coordinates) into information representing a set of incoming light rays in the following manner:

The X and Y offsets specify the location of the image formed by a central microlens on the surface of the sensor, referred to as MLXOnSensor and MLYOnSensor, respectively. The size of the image formed by the microlens is specified by the radius of the projected lenslet, referred to as MLROnSensor.

For each pixel, centered at PXOnSensor and PYOnSensor, if:

Sqrt((PXOnSensor−MLXOnSensor)²+(PYOnSensor−MLYOnSensor)²)<MLROnSensor,

then the pixel may be considered as in the projected image of specified microlens.

The locations of the centers of all projected microlens images onto the sensor surface may be determined by adding the spacing between neighboring lenslets, accounting for rotation. In an exemplary embodiment with a square microlens grid pattern, rotation of Theta relative to the sensor surface, and a spacing of MLSpacing between microlens images on the sensor surface, the 4 neighboring microlenses are centered at the following locations:

MLXOnSensor+MLSpacing*COS(Theta), MLYOnSensor+MLSpacing*SIN(Theta)

MLXOnSensor−MLSpacing*COS(Theta), MLYOnSensor+MLSpacing*SIN(Theta)

MLXOnSensor−MLSpacing*SIN(Theta), MLYOnSensor+MLSpacing*COS(Theta)

MLXOnSensor+MLSpacing*SIN(Theta), MLYOnSensorMLSpacing*COS(Theta)

The location of and spacing of the projection of the microlens disk on the sensor surface may determine the location and extents in X and Y components/coordinates of the 4 dimensional set of geometric rays. In an embodiment that converts locations on the imaging sensor to sets of values in X, Y, U, and V, the X and Y components of all pixels contained in a projected microlens image may be considered centered at the center of the microlens projection and have the same size as the entire area of the microlens. The U and V components may be considered angular information and may in some embodiments be determined in the following manner for a pixel centered at PXOnSensor, PYOnSensor under a microlens centered at MLXOnSensor, MLYOnSensor:

U=(PXOnSensor−MLXOnSensor)/MLSpacing

V=(PYOnSensor−MLYOnSensor)/MLSpacing

In these embodiments, U and V are in a normalized coordinate space ranging between −0.5 and 0.5.

Notably, in this embodiment any sensor pixels not illuminated (there is no projected microlens image with a center less than or equal to one projected disk radius from the location of the pixel) may not be used for Light Field Processing.

In certain embodiments, it may be advantageous that the locations and sizes of the projected lenslet disks onto the captured image are regular or near regular in appearance.

Compact Optical Specification of Capture System: In one embodiment, the system may store or record data which is representative of the (i) location and orientation of microlens array relative to the imaging sensor in 3-space, (ii) microlens grid pattern (for example, hexagonal or square), (iii) lens formulas or approximations for microlens array, (iv) lens formulas and spacings, or approximations for the main lens system, and/or (v) location and orientation of the light field sensor relative to the main lens system. (See, for example, FIGS. 5 and 6). Such data may be employed by the post-processing circuitry to determine a model of the optical path of the Light Field Data Acquisition Device.

The model may be employed by post-processing circuitry to perform Light Field Processing (for example, generate, manipulate and/or edit one or more images using the light field image data (for example, focusing or refocusing one or more images at different depths—post-data acquisition or after acquisition of the light field image data by the Light Field Data Acquisition Device)).

In one exemplary embodiment, the post-processing system acquires and/or determines (i) the x-offset of a central lenslet in the microlens array relative to the center of the imaging sensor, (ii) the y-offset of a central lenslet in the microlens array relative to the center of the imaging sensor, (iii) the rotation of the microlens array (iv) the separation of the microlens array from the imaging sensor, (v) the pitch of the microlens array, (vi) the pattern of the microlens array, and (vii) the location of the center of the exit pupil relative to the microlens array.

Characteristics, Parameters and/or Configurations Optical System and Lookup: In one embodiment, the system provides system, electronic, scene-dependent and/or optical characteristics, parameters, properties, models, and/or configurations via a lookup system. In a lookup system, according to one embodiment, the Light Field Data Acquisition Device stores or saves the Light Field Data with one or more keys identifying the optical system or components of the optical system of the acquisition device. For example, in one embodiment, a Light Field Data Acquisition Device may store a plurality of keys (for example, two keys), wherein one key may uniquely identify the Light Field Data Acquisition Device, and another key may uniquely identify the characteristics, parameters and/or configurations of the acquisition device when the Light Field Data was taken, acquired, and/or captured. Indeed, in one specific exemplary embodiment, the Light Field Data Acquisition Device according to this aspect of the inventions may have a fixed number of zoom configurations and a unique identifier for each of the zoom configurations—wherein each correspond to a predetermined key.

Notably, in one embodiment, the Light Field Data Acquisition Device may (in addition thereto or in lieu thereof) store or save an N-bit key to identify the characteristics, parameters and/or configurations of the acquisition device associated with or corresponding to the acquired or captured Light Field Data. In one exemplary embodiment, the Light Field Data Acquisition Device includes a key uniquely identifying one, some or all of the (dynamic and/or static) exposure characteristics, parameters and/or configurations of the Light Field Data Acquisition Device, including:
Data or information representing Aperture Function or Exit Pupil (for example, the size and/or shape and/or 3D position of the optical exit pupil of the lens system) of the Light Field Data acquisition system (or data/information which is representative thereof) relative to the microlens array. In one embodiment, the Exit Pupil may vary with each configuration of the lens system of the Light Field Data Acquisition Device. Indeed, size and/or shape of the Exit Pupil may change on a shot-by-shot basis. (See, FIGS. 2D, 5 and 6); and/or
The Light Field Sensor Geometry Model, which is defined generally as the optical and/or geometric model of the sensor that records Light Field Data. In a specific exemplary embodiment, this sensor is a microlens array in front of an image sensor array, and the Light Field Sensor Geometry Model may include one, some or all of the following characteristics, parameters and/or configurations:
   The geometry of the microlens array. In the context of the present inventions, “microlens array” is a term that may generally mean any window with a micro-optical patterning. Thus, the geometry of the microlens array would include the surface geometry of the micro-optical patterning; and/or
   The pitch of the lenslets in a microlens array. The pitch of the lenslets in the microlens array may be characterized as the distance between the centers of neighboring microlenses and may be fixed or constant for a predetermined model, series or version of Light Field Data Acquisition Device. In some embodiments, the pitch may be a single number that is constant and valid for all lenslets on the microlens array (See, FIGS. 7A and 7B). In other exemplary embodiments, the pitch may vary based on the spatial location in the microlens array. In other exemplary embodiments, the term “pitch” may be used generally to refer to the pattern of the microlens array, which may be regular, irregular, repeating or non-repeating; and/or
   The distance between the microlens array and the surface of the imaging sensor. In certain embodiments, it may be preferred that this distance is the same as (or substantially the same as) the focal length of the microlens array. (See, FIGS. 2B-2D) and/or
   The offsets and rotation of the microlens array relative to the imaging sensor.

The relative offsets and rotation of the microlens array may be fixed or constant for a predetermined model, series or version of Light Field Data Acquisition Device or may vary between Light Field Data Acquisition Devices (even between models, versions or pieces thereof). (See, FIG. 6); and/or
The pattern of the microlens array (for example, hex or square). The pattern of the microlens array may be fixed or constant for a predetermined model, series or version of Light Field Data Acquisition Device. (See, FIGS. 8A, 8B and 8C); and/or
The pitch of the pixels/sensors of the imaging sensor. The pitch of the pixels/sensors of the imaging sensor may be characterized as the distance between the centers of neighboring sensor pixels and may be fixed or constant for a predetermined model, series or version of Light Field Data Acquisition Device. (See, FIG. 9).

The N-bit key may be provided to post-processing circuitry which, using a look-up table or the like, may construct or reconstruct optical properties of the Light Field Data Acquisition Device. In one embodiment, the post-processing circuitry may access a resident memory, local database or query an external source (for example, an Internet source) for the optical information associated with the N-bit key.

In other exemplary embodiments employing one or multiple keys, one some or all of the keys may be encodings or representations of values for specific characteristics, parameters, models and or configurations within the Light Field Configuration Data. As a specific example, in some embodiments, the focal length of the zoom configuration may be represented or stored as an N-bit key, where the value of the N-bits encode an N-bit floating point bit-pattern for the focal length of the zoom position in millimeters. Notably, as mentioned above, each of the embodiments may be employed alone or in combination with one or more of the other embodiments. For example, in one embodiment, the optical model or data of the Light Field Data Acquisition Device may be represented using a combination of storing some configuration parameters as well as some information uniquely identifying certain elements or parts of the acquisition device (for example, based on the N-bit key embodiment discussed above). In this way, post-processing circuitry may read or interpret the data file(s) of the image data, the configuration data and the N-bit key, to create or recreate an optical model of the Light Field Data Acquisition Device which was employed to acquire and/or capture the Light Field Data (i.e., the optical model of the acquisition system which is associated with the Light Field Data).

In one exemplary embodiment, the translation and rotation configuration parameters of the microlens array relative to the image sensor are stored, recorded or saved to a file as well as the camera model number and zoom position. When this data is read by the post-processing circuitry of, for example, a post-processing system, a suitable geometric and/or optical model may be constructed by determining or looking up the optical system of the camera model at the particular zoom location (based on the N-bit key), and then applying the translation and rotation parameters of the microlens array to more fully express the geometric and/or optical model of the acquisition system which is associated with the Light Field Data.

Notably, in the exemplary embodiments hereof, the data processing, analyses, computations, generations and/or manipulations may be implemented in or with circuitry disposed (in part or in whole) in/on the camera or in/on an external post-processing system. Such circuitry may include one or more microprocessors, Application-Specific Integrated Circuits (ASICs), digital signal processors (DSPs), and/or programmable gate arrays (for example, field-programmable gate arrays (FPGAs)). Indeed, the circuitry may be any type or form of circuitry whether now known or later developed. For example, the post-processing circuitry may include a single component or a multiplicity of components (microprocessors, FPGAs, ASICs and DSPs), either active and/or passive, which are coupled together to implement, provide and/or perform a desired operation/function/application; all of which are intended to fall within the scope of the present invention.

The term “circuit” may mean, among other things, a single component (for example, electrical/electronic) or a multiplicity of components (whether in integrated circuit form, discrete form or otherwise), which are active and/or passive, and which are coupled together to provide or perform a desired function. The term “circuitry” may mean, among other things, a circuit (whether integrated, discrete or otherwise), a group of such circuits, one or more processors, one or more state machines, one or more processors implementing software, or a combination of one or more circuits (whether integrated, discrete or otherwise), one or more state machines, one or more processors, and/or one or more processors implementing software. Moreover, the term “optics” means a system comprising a plurality of components used to affect the propagation of light, including but not limited to lens elements, windows, apertures and mirrors.

Further, as mentioned above, in operation, the post-processing circuitry may perform or execute one or more applications, routines, programs and/or data structures that implement particular methods, techniques, tasks or operations described and illustrated herein. The functionality of the applications, routines or programs may be combined or distributed. Further, the applications, routines or programs may be implementing by the post-processing circuitry using any programming language whether now known or later developed, including, for example, assembly, FORTRAN, C, C++, and BASIC, whether compiled or uncompiled code; all of which are intended to fall within the scope of the present invention.

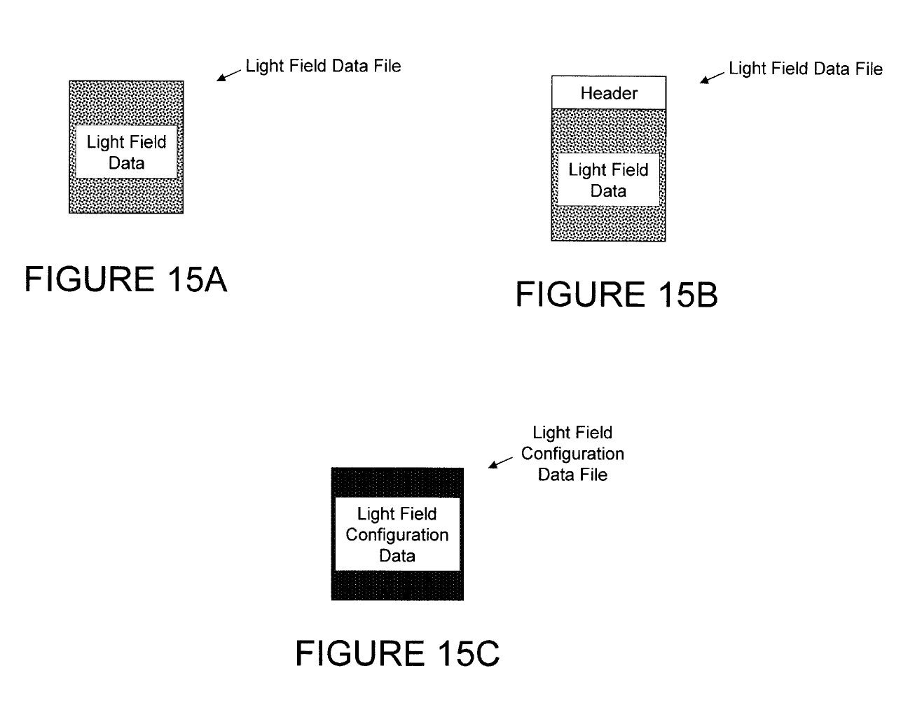

Exemplary File and File Structure of Light Field Data: A Light Field Data File is an electronic data file which includes one or more sets of Light Field Data. (See, for example, FIGS. 15A and 15B). The Light Field Data File may include one or more sets of Light Field Data which, in whole or in part, is compressed or uncompressed and/or processed or unprocessed. A set of Light Field Data may be data of a scene, image or “exposure” acquired, captured and/or sampled via a Light Field Data Acquisition Device.

The Light Field Data File may include any file format or structure, whether the data contained therein is, in whole or in part, in compressed or uncompressed form, and/or whether the data contained therein is, in whole or in part, processed or unprocessed. In one exemplary embodiment, file format or structure of the Light Field Data file includes a start code and/or end code to indicate the beginning and/or end, respectively, of a set of a Light Field Data. In addition thereto, or in lieu thereof, the set of Light Field Data may include a predetermined or predefined amount of data. (See, for example, FIG. 15A). As such, the start or end of a given set of Light Field Data may be indirectly based on an amount of data (with or without start and/or end codes). Notably, any file format or file structure of the Light Field Data file, whether now known or later developed, is intended to fall within the scope of the present invention.

In one exemplary embodiment, the file format or structure of the Light Field Data may include metadata (for example, as a header section). (See, for example, FIG. 15B wherein in this exemplary embodiment, such header is located in the beginning of the file—although it need not). In one embodiment, the metadata may be definitional type data that provides information regarding the Light Field Data and/or the environment or parameters in which it was acquired, captured and/or sampled. For example, the metadata may include and/or consist of Light Field Configuration Data.

As noted above, the Light Field Data File may include one or more sets of Light Field Data of an image or “exposure” acquired, captured and/or sampled via a Light Field Data Acquisition Device. Where the file includes a plurality of sets of Light Field Data, such sets may be a series of images or exposures (temporally contiguous) or a plurality of images that were acquired using the same or substantially the same acquisition settings. Under these circumstances, the header section may include and/or consist of Light Field Configuration Data that is applicable to the plurality of sets of Light Field Data.

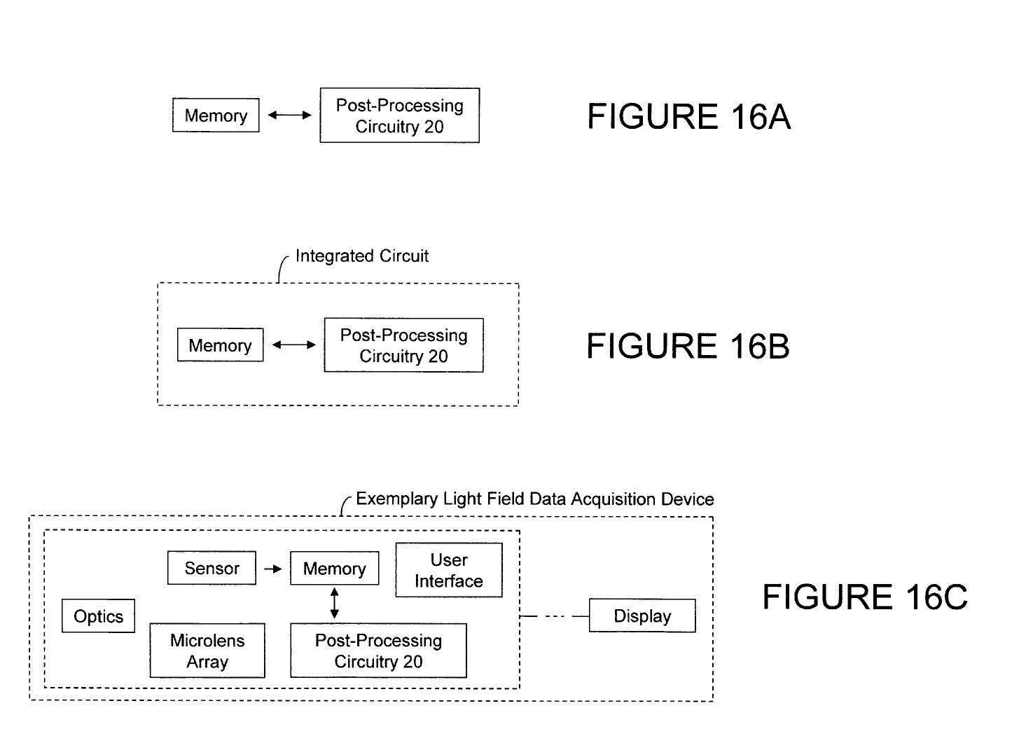

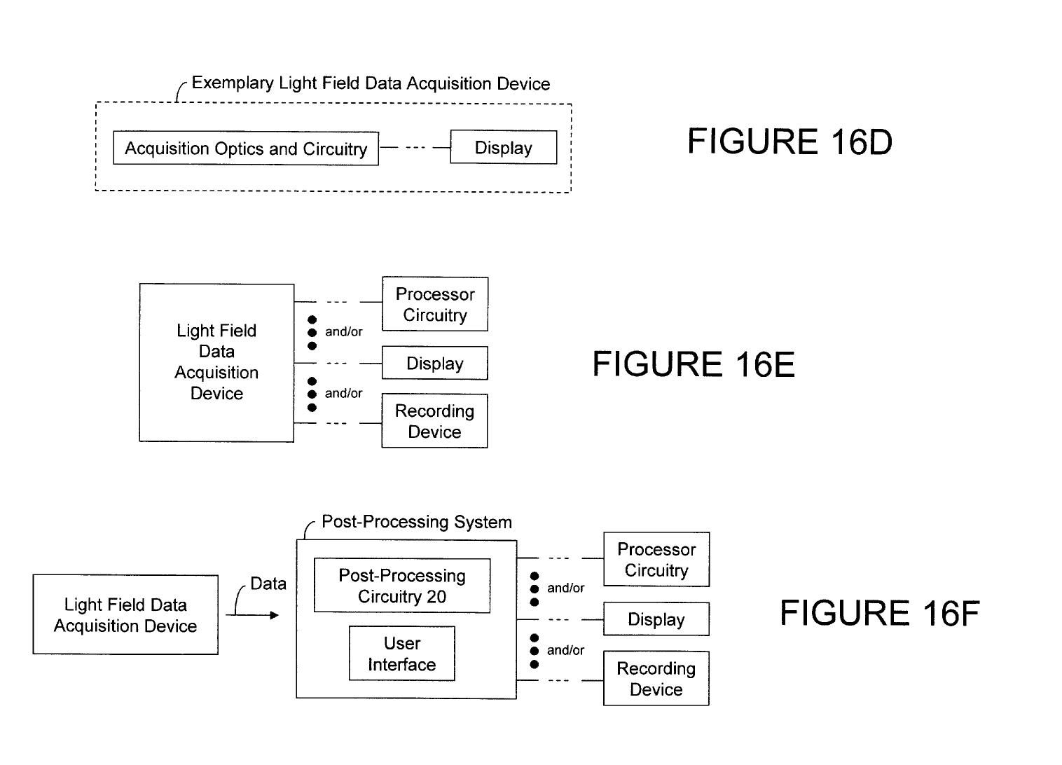

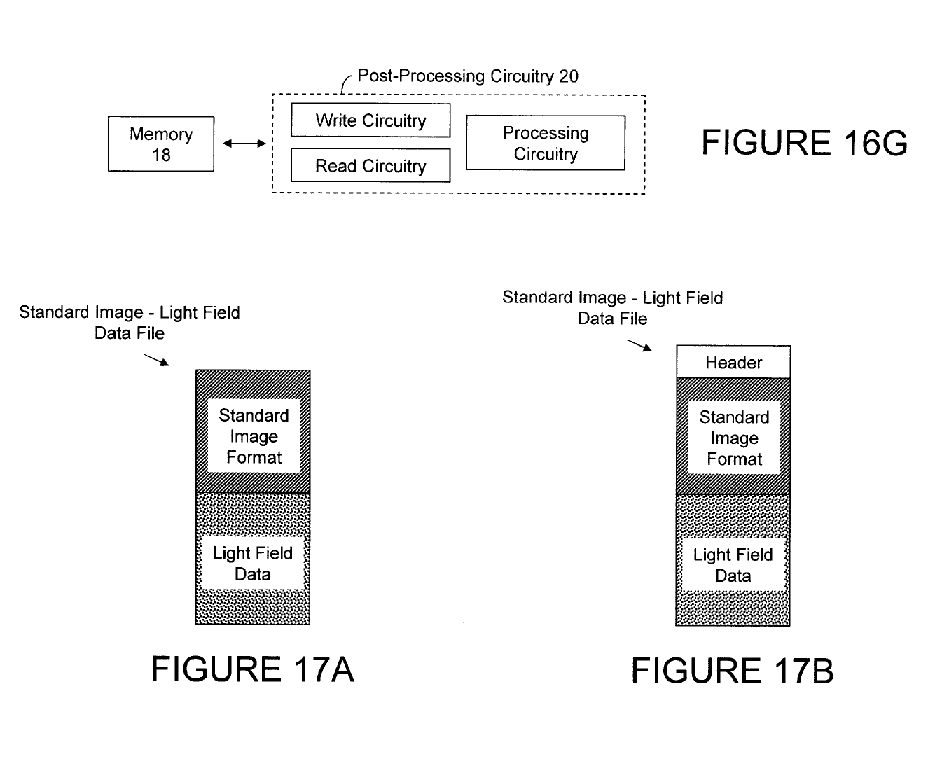

The Light Field Data File may be stored and/or maintained in memory (for example, DRAM, SRAM, Flash memory, conventional-type hard drive, tape, CD and/or DVD). (See, for example, FIGS. 16A-16C). Such memory may be accessed by post-processing circuitry to perform Light Field Processing (for example, generating, manipulating and/or editing the image data corresponding to the Light Field Data—after acquisition or recording thereof (including, for example, adjusting, selecting, defining and/or redefining the focus and/or depth of field after acquisition of the Light Field Data)). The memory may be internal or external to the Light Field Data Acquisition Device. Further, the memory may be discrete or integrated relative to the circuitry in the Light Field Data Acquisition Device. In addition thereto, or in lieu thereof, the memory may be discrete or integrated relative to the post-processing circuitry/system.

In one embodiment, the post-processing circuitry may access the Light Field Data File (having one or more sets of Light Field Data) and, based on or in response to user inputs or instructions, perform Light Field Processing (for example, adjusting, selecting, defining and/or redefining the focus and/or depth of field of an image after acquisition of Light Field Data associated with such image). Thereafter, the post-processing circuitry may store the image within the Light Field Data File (for example, append such image thereto) and/or overwrite the associated Light Field Data contained in the Light Field Data File. In addition thereto, or in lieu thereof, the post-processing circuitry may create (in response to user inputs/instructions) a separate file containing the image which was generated using the associated Light Field Data. This process may be repeated to perform further Light Field Processing and generate additional images using the Light Field Data (for example, re-adjust, re-select and/or re-define a second focus and/or a second depth of field of the second image associated with the same Light Field Data as the first image—again after acquisition of Light Field Data associated with such images).

Notably, the Light Field Data Acquisition Device may include a display to allow the user to view an image or video generated using one or more sets of Light Field Data. (See for example, FIGS. 16C and 16D). The display may facilitate the user to implement desired or predetermined Light Field Processing of one or more sets of Light Field Data in a Light Field Data File.

The Light Field Data Acquisition Device may also couple to an external display as well as, for example, a recording device, memory, printer and/or processor circuitry (See, for example, FIGS. 16E and 16F). In this way, the Light Field Data Acquisition Device or post-processing circuitry may output image data to display, processor circuitry (for example, a special purpose or general purpose processor), and/or a video recording device. (See, for example, FIGS. 16E and 16F). Moreover, such external devices or circuitry may facilitate, for example, storage of Light Field Data Files and Light Field Processing of Light Field Data Files.

The Light Field Data Acquisition Device (and/or the post-processing system) may communicate with memory (which may store the electronic data files having one or more sets of Light Field Data and/or Light Field Configuration Data) via write circuitry and read circuitry. (See, FIG. 16G). The write and read circuitry may couple to processing circuitry to implement, for example, Light Field Processing which generates, manipulates and/or edits (for example, adjusting, selecting, defining and/or redefining the focus and/or depth of field) the image data corresponding to the Light Field Data—after acquisition or recording thereof. The processing circuitry (for example, one or more processors, one or more state machines, one or more processors implementing software, one or more gate arrays, programmable gate arrays and/or field programmable gate arrays) may generate electronic data files including Light Field Data (for example, in a compressed or non-compressed form. As discussed in detail below, such files may include the Light Field Data which is interleaved, threaded, watermarked, encoded, multiplexed and/or meshed into the data of the Standard Image Format.

Notably, as discussed herein, Light Field Configuration Data may be stored in a header or in an electronic file that is separate from the electronic file(s) containing the associated Light Field Data. (See, for example, FIGS. 15B and 15C). Where the Light Field Configuration Data is stored in a separate electronic file, such file may be stored and/or maintained in memory (for example, DRAM, SRAM, Flash memory, conventional-type hard drive, tape, CD and/or DVD). (See, for example, FIGS. 16A-16C). As noted above, such memory may be accessed by post-processing circuitry to perform Light Field Processing (for example, generating, manipulating and/or editing the image data corresponding to the Light Field Data—after acquisition or recording thereof (including, for example, adjusting, selecting, defining and/or redefining the focus and/or depth of field after acquisition of the Light Field Data using the Light Field Configuration Data)). Again, the memory may be internal or external to the Light Field Data Acquisition Device and/or the post-processing system. Further, the memory may be discrete or integrated relative to the circuitry in the Light Field Data Acquisition Device. In addition thereto, or in lieu thereof, the memory may be discrete or integrated relative to the post-processing circuitry/system.

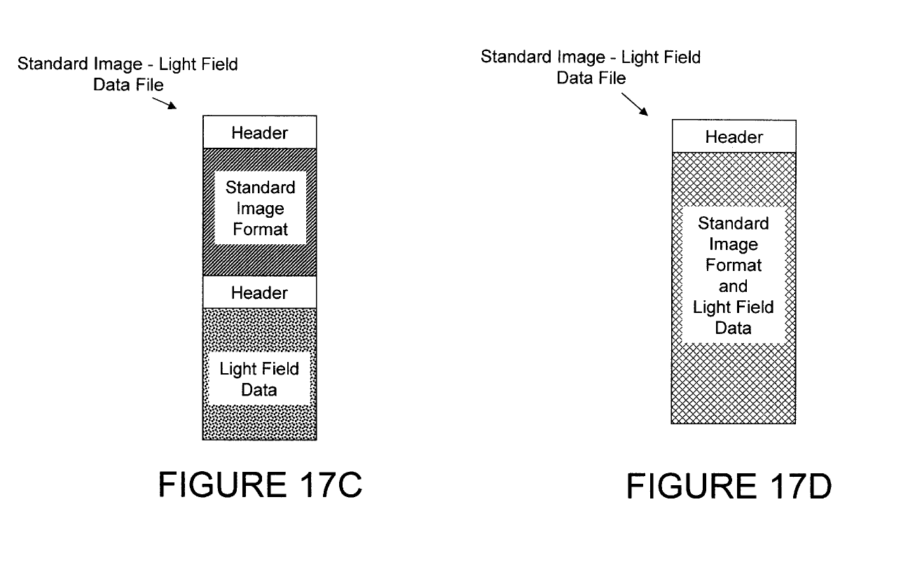

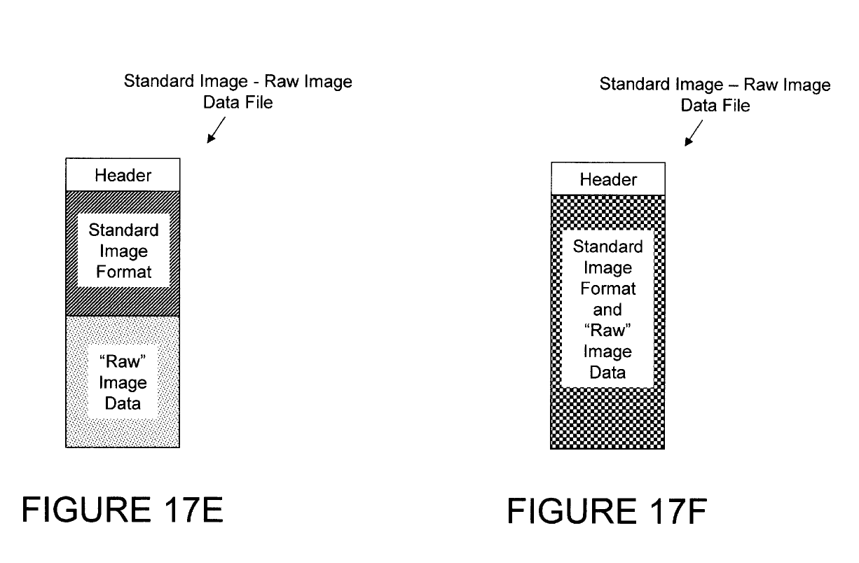

Additional Exemplary File and File Structure including Light Field Data and/or Raw Image Data: In another set of embodiments, one or more sets of Light Field Data may be appended to or integrated into image data in or having a Standard Image Format. (See, for example, FIGS. 17A-17C). In these embodiments, the one or more sets of Light Field Data is/are associated with the image data in a Standard Image Format in that such one or more sets of Light Field Data may be used to generate the image which is represented in the Standard Image Format. The Light Field Data may include one or more sets of Light Field Data which, in whole or in part, is compressed or uncompressed and/or processed or unprocessed. Notably, the Standard Image Format may be an open format or a proprietary format.

The Light Field Data in the Standard Image Format—Light Field Data File may include any of the attributes and/or characteristics discussed above in conjunction with the Light Field Data File. For example, in one exemplary embodiment, the electronic data file may include metadata. (See, for example, FIG. 17B). In one exemplary embodiment, the Light Field Data may include metadata (for example, Light Field Configuration Data in a header section). (See, for example, FIG. 17C wherein in this exemplary embodiment, such header is located in the beginning of the file—although it need not). Indeed, the metadata of the Light Field Data may be incorporated into the metadata associated with the Standard Image Format. Although the attributes and/or characteristics of the Light Field Data File discussed above are applicable to the Light Field Data in the Standard Image Format—Light Field Data File, for the sake of brevity, such discussion will not be repeated here.

In one embodiment, the Light Field Data is interleaved, threaded, watermarked, encoded, multiplexed and/or meshed into the data of the Standard Image Format. (See, for example, FIG. 17D). In this embodiment, processing or reading circuitry may extract and/or decode the data of the image in the Standard Image Format relative to the data set(s) of the Light Field Data.

Notably, in another set of embodiments, the non-light field raw image data which was employed to generate the image data in the Standard Image Format, may be appended to or integrated into image data in a Standard Image Format. (See, for example, FIGS. 17E and 17F). In these embodiments, the raw image data (which may or may not be Light Field Data) which is associated with the image data in a Standard Image Format is stored in the same file as the image data in a Standard Image Format. Such raw image data may be compressed or uncompressed and/or processed (in whole or in part) or unprocessed. In one exemplary embodiment, such raw data is a representation of the original single-channel raw pixel values read off a sensor with a color mosaic filter array (for example, Bayer color filter array). In another specific exemplary embodiment, such raw pixel values are from a Light Field Data Acquisition Device, and hence the raw data is a representation of Light Field Data recorded by such a device.

In these embodiments, Light Field Configuration Data may be stored in the header or in an electronic file that is separate from the associated Light Field Data. (See, for example, FIGS. 15C, 17B and 17C). Where the Light Field Configuration Data is stored in a separate electronic file, such file may be stored and/or maintained in memory and accessed during processing of the image corresponding to or in the Standard Image Format and/or the Light Field Data (for example, as discussed immediately below).

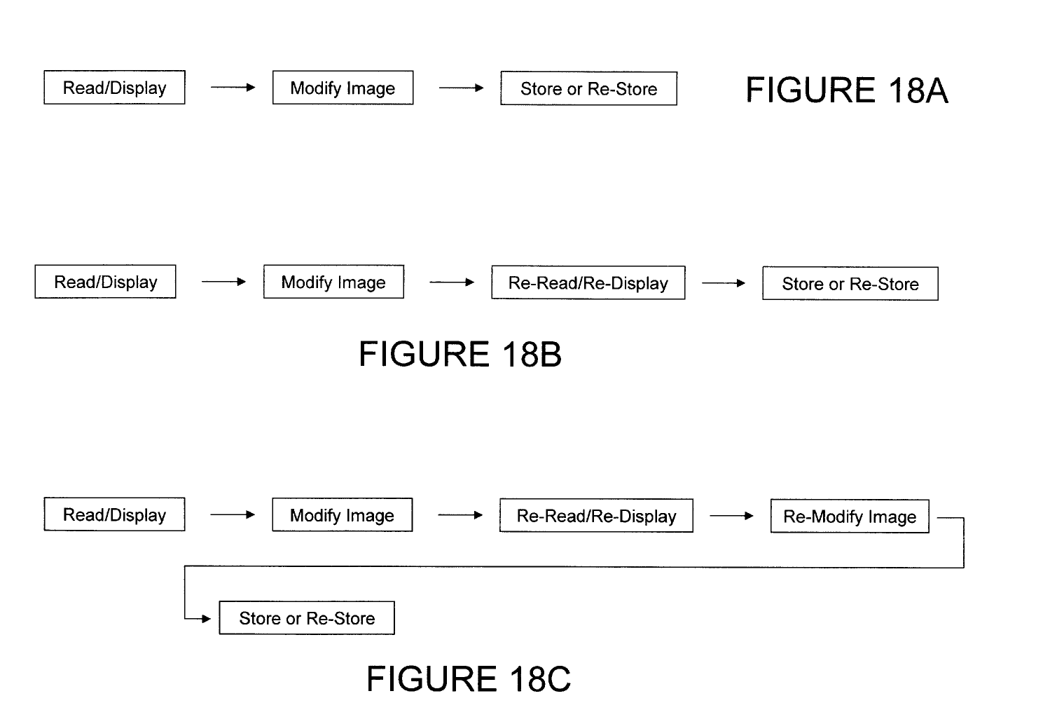

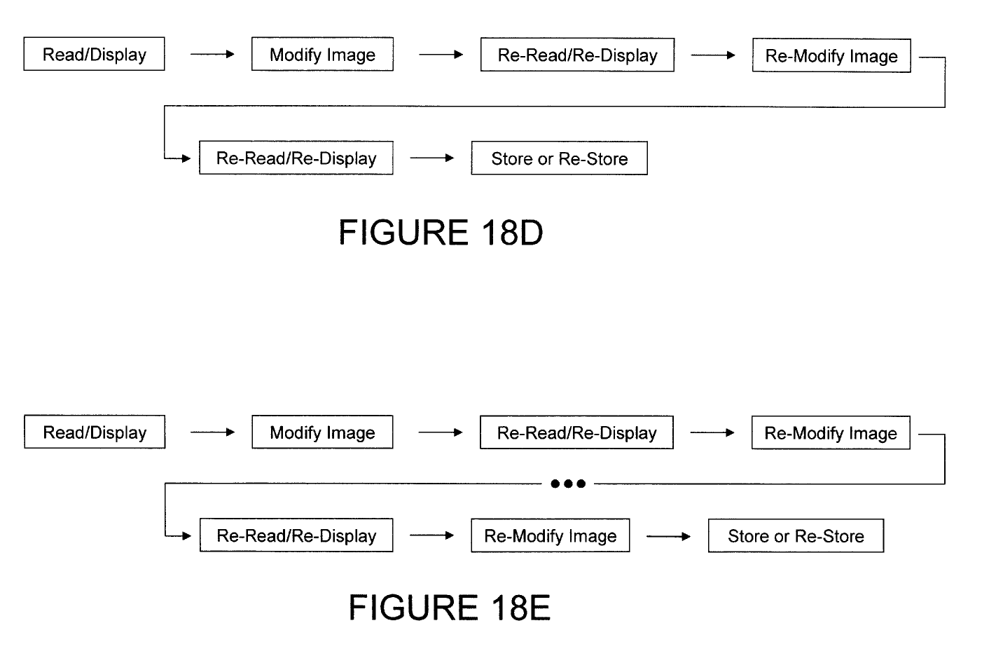

Exemplary Processing of Files and File Structures including Light Field Data and/or Raw Image Data: With reference to FIG. 18A, in one embodiment, circuitry may access a Data File illustrated in FIGS. 17A-17F (for example, a Standard Image Format—Light Field Data File) and read or display the image corresponding to the Standard Image Format. Thereafter, and based on or in response to one or more inputs or instructions (for example, user inputs or instructions), the image corresponding to the Standard Image Format may be modified using, for example, the one or more data sets of the Light Field Data associated with the image. In one embodiment, based on or in response to one or more inputs or instructions, circuitry may perform Light Field Processing (for example, adjusting, selecting, defining and/or redefining the focus and/or depth of field of an image after acquisition of Light Field Data associated with such image (wherein the image during acquisition included an original focus and depth of field)) to modify the image and thereby provide a new image (having, for example, a new focus and/or depth of field). Thereafter, the circuitry may store or re-store the image within the Data File (for example, (i) replace or overwrite the previous image by storing data in the Standard Image Format which is representative of the new image or (ii) append data in the Standard Image Format which is representative of the such new image). In addition thereto, or in lieu thereof, the circuitry may create (in response to, for example, user inputs/instructions) a separate file containing data corresponding to the new image. Indeed, in addition to the data (in the Standard Image Format) which is representative of the image, such new or separate file may or may not contain the Light Field Data associated therewith.

Notably, when the circuitry is performing Light Field Processing to generate the modified image, the circuitry may employ the Standard Image Format—Light Field Data File (or a portion thereof) as a frame buffer. Such a technique provides for efficient use of memory resources.

In another exemplary embodiment, the present inventions utilize the standard image portion of the Standard Image Format—Light Field Data File as a “File Framebuffer.” Specifically, this File Framebuffer that represents the pixels to be displayed, is displayed on any display via any Standard Display Mechanism (i.e. method or system, whether now known or developed in the future, that may read, interpret and/or display the standard image portion of the Data File). In order to illustrate the principles, the Standard Display Mechanism may, for example, be one of: a web browser; an image viewer that is possibly integrated with an operating system; a third-party piece of software for image organization, viewing editing and/or slideshows; an internet-based photo sharing website or service; a printing service such as a kiosk at a departmental store; and an internet-based printing service that enables upload of Standard Image Formats. Notably, such Standard Display Mechanisms may not be able to interpret, process and/or display the Light Field Data portion of the Standard Image—Light Field Data File. In this exemplary embodiment, the modify—store/restore component makes use of the Light Field Data portion of the file in order to create a modified image through Light Field Processing, replacing the “File Framebuffer” in order to provide new pixels for Standard Display Mechanisms. Notably, the “File Framebuffer” serves as a persistent store of pixels for the present invention to store/restore the effect of the “modify” component for potential display on any Standard Display Mechanism. The process of read/display—modify—store/re-store may include many permutations and/or combinations. For example, after modifying the image (using the Light Field Data which is associated therewith) to generate the new image, such new image may be re-read or re-displayed. (See, for example, FIG. 18B). Indeed, prior to storing/re-storing data which is representative of the new image (in the Standard Image Format), the user may instruct the circuitry to perform a re-modify (i.e., modify the original image again or modify the new image). (See, for example, FIG. 18C). All permutations and/or combinations of read/display—modify—store/re-store are intended to fall within the scope of the present inventions (see, for example, FIGS. 18D and 18E); however, for the sake of brevity, such permutations and/or combinations of read/display—modify—store/re-store will not be discussed separately herein.

Notably, when storing or re-storing the image within the Data File (for example, (i) replace or overwrite the previous image by storing data in the Standard Image Format which is representative of the new image or (ii) append data in the Standard Image Format which is representative of the such new image), the circuitry may, in response to user inputs or instructions, generate a new Standard Image Format—Light Field Data File (wherein the Light Field Data may be substantially unchanged) or generate a Standard Image File only (i.e., discard the Light Field Image Data). The user may also instruct the circuitry to change the standard format of the Standard Image File prior to storing or re-storing the data (in the selected Standard Image Format) which is representative of the modified image.

As indicated above, the read/display—modify—store/re-store process is also applicable to the Standard Image Format—Raw Image Data File illustrated in FIGS. 17D and 17E. The process in connection with the Standard Image Format—Raw Image Data File is substantially similar to the process for the Standard Image Format—Light Field Image Data File (discussed immediately above) and, as such, for the sake of brevity, the discussion will not be repeated.

In an exemplary embodiment of the read/display—modify—store/re-store process for the Standard Image—Raw Image Data File, the modify portion of the process includes any type of processing that is accessible and/or possible from the Raw Image data. Notably, such type of processing may not be accessible and/or possible from the Standard Image data alone. For example, such processing includes, but is not limited to: changing the white-balance information to affect appearance of color; changing the exposure level to brighten or darken the image; applying dynamic range alteration in order to, for example, reducing the dynamic range by raising the brightness of the dark areas and reducing the brightness of the light areas. Notably, any type of image processing that is applicable to Raw Image data, whether now known or developed in the future, is intended to fall within the scope of the present inventions.

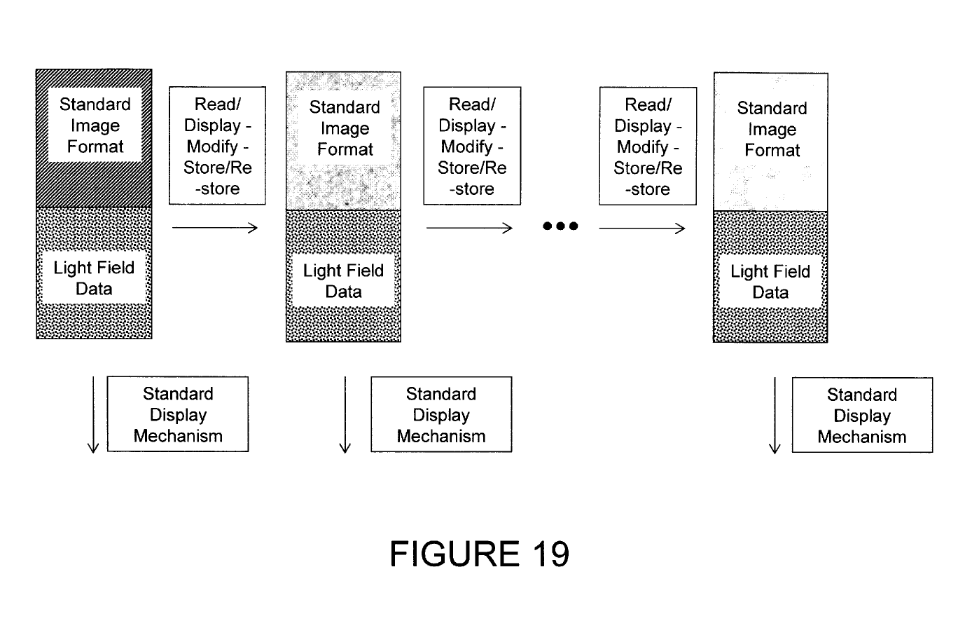

Exemplary Mixed-Mode Display, Processing and Communication. With reference to FIG. 19, in one embodiment, a user may utilize any Standard Display Mechanism to view the Standard Image portion of a Data File (for example, the exemplary electronic data files of FIGS. 17A-17F), reading and/or displaying the image corresponding to the Standard Image Format; a user may also utilize the read/display—modify—store/re-store process described above, possibly changing the Standard Image and/or Light Field Data within the Data File. A user may subsequently utilize a Standard Display Mechanism on the resulting Data File, for example to view or share the image via the internet, or to print it via a printing service. A user may subsequently repeat this process any number of times.

The following is an exemplary scenario utilizing an embodiment of the present inventions and, as such, is not intended to be limiting to the permutations and/or combinations of read/display—modify—store/re-store embodiments. With that in mind, in one exemplary embodiment, the user acquires a Data File in a Standard Image Format—Light Field Data format, for example, via a recording from a Light Field Data Acquisition Device. The Light Field Data Acquisition Device, in response to inputs/instructions (for example, user inputs/instructions), communicates the Data File to a computer system, which includes a image viewing computer program (for example, Standard Display Mechanisms) to provide and allow viewing of the Data File as an image on a display. The Light Field Data Acquisition Device and/or computer system, in response to inputs/instructions (for example, user inputs/instructions), may also communicate the Data File to an internet image sharing site (another Standard Display Mechanism), for example, in order to facilitate sharing of the Data File.

Another user may then download the Data File from the sharing site, and view it on a computer (Standard Display Mechanism which is, for example, local to the second user). The second user, employing a computer system, may open the Data File with a software program that implements the Read/Display—Modify—Store/Re-store process. The second user views the image, and applies or implements Light Field Processing (for example, changes the optical focus of the image on to a closer focal plane), and stores the resulting image into the File Framebuffer comprising the Standard Image portion of the Data File in the Standard Image Format. The second user then prints the Data File using a printer (another Standard Display Mechanism). The second user may then upload the Data File to an Internet image sharing site (Standard Display Mechanism), which may be the same or a different sharing site. Another user (i.e., the first user or a third user) downloads the Data File and prints it. The preceding scenario illustrates certain aspects and exemplary embodiments of the present invention.

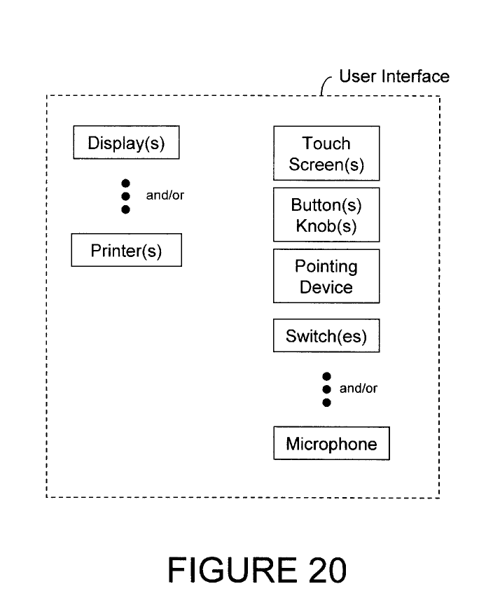

Notably, the Light Field Data Acquisition Device and/or post-processing system may include a user interface to allow a user/operator to monitor, control and/or program acquisition device and/or post-processing system. (See, for example, FIGS. 1B, 1C, 1E, 1F, 16C, 16F, and 20). With reference to FIG. 20, in one embodiment, user interface may include an output device/mechanism (for example, printer and/or display (Standard Display Mechanism) and/or user input device/mechanism (for example, buttons, switches, touch screen, pointing device (for example, mouse or trackball) and/or microphone) to allow a user/operator to monitor, control and/or the program operating parameters and/or characteristics of the Light Field Data Acquisition Devices and/or post-processing circuitry/system (for example, (i) the rates of acquisition, sampling, capture, storing and/or recording of Light Field Data, (ii) the focal plane, field of view or depth of field of acquisition device, and/or (iii) the post-processing operations implemented by the post-processing circuitry/system).

There are many inventions described and illustrated herein. While certain embodiments, features, attributes and advantages of the inventions have been described and illustrated, it should be understood that many others, as well as different and/or similar embodiments, features, attributes and advantages of the present inventions, are apparent from the description and illustrations. As such, the above embodiments of the inventions are merely exemplary. They are not, nor are they intended to be exhaustive or to limit the inventions to the precise forms, techniques, materials and/or configurations disclosed. It is to be understood that such other, similar, as well as different, embodiments, features, materials, configurations, attributes, structures and advantages of the present inventions are within the scope of the present invention. It is to be further understood that other embodiments may be utilized and operational changes may be made without departing from the scope of the present inventions. The scope of the inventions is not limited solely to the description above because the description of the above embodiments has been presented for the purposes of exemplary illustration and description.

For example, in those embodiments where the Light Field Data Acquisition Device connects to a post-processing system, such connection may be via wired and/or wireless architectures using any signaling technique now known or later developed. In addition, the configuration data may be provided and/or communicated to a post-processing system together with or separate from the associated Light Field Data using any format know known or later developed. Indeed, the static-type configuration data may be provided and/or communicated to a post-processing system together with or separate from dynamic-type configuration data. All communication strategies, designs, formats, techniques and/or architectures relating thereto are intended to fall within the scope of the present inventions.

It should be further noted that the various circuits and circuitry disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and HLDL, formats supporting register level description languages like RTL, and formats supporting geometry description languages such as GDSII, GDSIII, GDSIV, CIF, MEBES and any other suitable formats and languages. Computer-readable media in which such formatted data and/or instructions may be embodied include, but are not limited to, non-volatile storage media in various forms (for example, optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (for example, HTTP, FTP, SMTP, etc.).

Indeed, when received within a computer system via one or more computer-readable media, such data and/or instruction-based expressions of the above described circuits may be processed by a processing entity (for example, one or more processors) within the computer system in conjunction with execution of one or more other computer programs including, without limitation, net-list generation programs, place and route programs and the like, to generate a representation or image of a physical manifestation of such circuits. Such representation or image may thereafter be used in device fabrication, for example, by enabling generation of one or more masks that are used to form various components of the circuits in a device fabrication process.

As noted above, there are many inventions described and illustrated herein. Importantly, each of the aspects of the present invention, and/or embodiments thereof, may be employed alone or in combination with one or more of such aspects and/or embodiments. For the sake of brevity, those permutations and combinations will not be discussed separately herein. As such, the present invention is not limited to any single aspect or embodiment thereof nor to any combinations and/or permutations of such aspects and/or embodiments.

In the claims, the terms (i) “light field data” means Light Field Data, (ii) “light field configuration data” means Light Field Configuration Data, (iii) “aperture function” means Aperture Function, (iv) “exit pupil” means Exit Pupil, (v) “light field processing” means Light Field Processing, (vi) “light field data file” means Light Field Data File, (vi) “optical model” means optical and/or geometric model, (vii) “standard image format” means Standard Image Format.

Further, in the claims, the term “circuit” means, among other things, a single component (for example, electrical/electronic) or a multiplicity of components (whether in integrated circuit form, discrete form or otherwise), which are active and/or passive, and which are coupled together to provide or perform a desired operation. The term “circuitry”, in the claims, means, among other things, a circuit (whether integrated or otherwise), a group of such circuits, one or more processors, one or more state machines, one or more processors implementing software, one or more gate arrays, programmable gate arrays and/or field programmable gate arrays, or a combination of one or more circuits (whether integrated or otherwise), one or more state machines, one or more processors, one or more processors implementing software, one or more gate arrays, programmable gate arrays and/or field programmable gate arrays. The term “data” means, among other things, a current or voltage signal(s) (plural or singular) whether in an analog or a digital form, which may be a single bit (or the like) or multiple bits (or the like). Moreover, the term “optics”, means one or more components and/or a system comprising a plurality of components used to affect the propagation of light, including but not limited to lens elements, windows, microlens arrays, apertures and mirrors.

What is claimed is:

1. A method of generating and outputting image data corresponding to a scene, the method comprising:
acquiring light field data which is representative of a light field from the scene, wherein the light field data is acquired using a data acquisition device;
acquiring configuration data which is representative of how light rays optically propagate through the data acquisition device;
generating first image data using the light field data and the configuration data, wherein the first image data includes a focus or focus depth that is different from a focus or focus depth of the light field data;
generating a first electronic data file including (i) the first image data, (ii) the light field data, and (iii) the configuration data; and
outputting the first electronic data file.

2. The method of claim 1 wherein generating the first electronic data file further includes arranging the first image data of the first electronic data file in a standard image format.

3. The method of claim 1 wherein generating the first electronic data file further includes arranging the first image data of the first electronic data file in a JPEG format.

4. The method of claim 2 wherein generating a first electronic data file further includes interleaving, threading, watermarking, encoding, multiplexing and/or meshing the first image data and the light field data.

5. The method of claim 2 wherein generating a first electronic data file further includes generating a header of the first electronic data file, wherein the header includes the configuration data.

6. The method of claim 2 further including:
reading the first electronic data file;
displaying the first image data;
receiving a user input;
generating second image data, in response to the user input, using (i) the light field data of the electronic data file and (ii) the configuration data, wherein the second image data is different from the first image data;
generating a second electronic data file including (i) the second image data, (ii) the light field data, and (iii) the configuration data; and
outputting the second electronic data file.

7. The method of claim 6 wherein the second image data includes a focus or focus depth that is different from the focus or focus depth of the first image data.

8. The method of claim 7 wherein generating the second electronic data file further includes arranging the second image data of the second electronic data file in a standard image format.

9. The method of claim 6 wherein generating a second electronic data file further includes interleaving, threading, watermarking, encoding, multiplexing and/or meshing the second image data and the light field data.

10. The method of claim 2 further including compressing the light field data to generate compressed light field data, and wherein the light field data of the first electronic data file is the compressed light field data.

11. The method of claim 2 wherein:
acquiring configuration data includes acquiring an N-bit key; and
the method further includes determining optical model data by correlating the N-bit key to predetermined optical model data and wherein generating first image data includes generating first image data using the light field data and the optical model data.

12. The method of claim 2 further including:
reading the first electronic data file;
displaying the first image data;
receiving a user input;
generating second image data, in response to the user input, using (i) the light field data of the electronic data file and (ii) the configuration data, wherein the second image data is different from the first image data;
generating a second electronic data file including the second image data; and
outputting the second electronic data file.

13. The method of claim 12 wherein the second image data includes a focus or focus depth that is different from the focus or focus depth of the first image data.

14. The method of claim 13 wherein generating the second electronic data file further includes arranging the second image data of the second electronic file in a standard image format.

15. The method of claim 1 wherein the configuration data includes data which is representative of an aperture function or an exit pupil which is associated with the acquisition of the light field data.

16. The method of claim 1 wherein the configuration data includes data which is representative of a mapping from a two-dimensional position on a captured 2D array of pixel values of the data acquisition device to a four-dimensional parameterization of the light field from the scene.

17. A system comprising:
read circuitry to read a first electronic data file which is stored in a memory, wherein the first electronic data file includes (i) first image data, (ii) light field data which is representative of a light field from a scene, and (iii) configuration data which is representative of how light rays optically propagate through a light field data acquisition device;
a display to visually output an image of the scene using the first image data;
a user interface to receive a user input;
processing circuitry, coupled to the read circuitry, display and user interface, to:
determine an optical model data using the configuration data, wherein the optical model data is representative of an optical model of the light field data acquisition device,
generate second image data, in response to the user input, using the light field data and the optical model data, wherein the second image data includes a focus or focus depth that is different from a focus or focus depth of the first image data, and
generate a second electronic data file including the second image data; and
write circuitry, coupled to the processing circuitry, to write the second electronic data file to the memory.

18. The system of claim 17 wherein the second electronic data file further includes (i) the light field data which is representative of a light field from the scene, and (ii) the configuration data and/or the optical model data.

19. The system of claim 18 wherein the configuration data includes data which is representative of an aperture function or an exit pupil which is associated with the light field data acquisition device that acquired the light field data.

20. The system of claim 18 wherein the processing circuitry generates the second electronic data file by interleaving, threading, watermarking, encoding, multiplexing and/or meshing the second image data and the light field data.

21. The system of claim 18 wherein the second electronic data file includes a header, wherein the header includes the configuration data and/or the optical model data.

22. The system of claim 18 wherein the processing circuitry generates the first electronic data file by compressing the light field data to generate compressed light field data, and wherein the light field data of the second electronic data file is the compressed light field data.

23. The system of claim 17 wherein the processing circuitry arranges the second image data of the second electronic data file in a standard image format.

24. The system of claim 17 wherein the processing circuitry arranges the second image data of the second electronic data file in a JPEG format.

25. The system of claim 17 wherein the configuration data of the first electronic data file includes an N-bit key, and wherein the processing circuitry determines the optical model data by correlating the N-bit key to a plurality of different, predetermined optical model data.

26. A light field acquisition device for acquiring light field image data of a scene, the device comprising:
optics, wherein the optics includes an optical path;
a light field sensor, located in the optical path of the optics, to acquire light field image data;
a user interface to receive a user input, wherein, in response to the user input, the light field sensor acquires the light field image data of the scene; and
processing circuitry, coupled the light field sensor and the user interface, to generate and output an electronic data file, the processing circuitry to:
determine configuration data which is representative of how light rays optically propagate through the optics and light field sensor; and
generate and output the electronic data file, wherein the electronic data file includes (i) image data, (ii) light field data which is representative of a light field from the scene, and (iii) configuration data; and
memory, coupled to the processing circuitry, to store the electronic data file therein.

27. The device of claim 26 wherein the configuration data includes data which is representative of an aperture function or exit pupil of the light field acquisition device.

28. The device of claim 26 wherein the configuration data includes data which is representative of a mapping from a two-dimensional position on a captured 2D array of pixel values to a four-dimensional parameterization of a light field from the scene.

29. The device of claim 26 wherein the processing circuitry generates the electronic data file by interleaving, threading, watermarking, encoding, multiplexing and/or meshing the image data and the light field data.

30. The device of claim 26 wherein the processing circuitry generates a header which includes the configuration data, wherein the electronic data file includes the header.

31. The device of claim 26 wherein the processing circuitry generates the electronic data file by compressing the light field data to generate compressed light field data, and wherein the light field data of the electronic data file is the compressed light field data.

32. The device of claim 26 wherein the processing circuitry arranges the image data of the electronic data file in a standard image format.

33. The device of claim 26 wherein the processing circuitry arranges the image data of the electronic data file in a JPEG format.

34. The device of claim 26 wherein the configuration data of the electronic data file includes an N-bit key which is representative of predetermined optical model data.
